(19) United States
(12) Patent Application Publication
(10) Pub. No.: US 2006/0179277 A1
(43) Pub. Date: Aug. 10, 2006

(54) System and method for instruction line buffer holding a branch target buffer

(76) Inventors: Brian King Flachs, Georgetown, TX (US); Brad William Michael, Cedar Park, TX (US)

Correspondence Address: IBM CORPORATION- AUSTIN (JVL);C/O VAN LEEUWEN & VAN LEEUWEN, PO BOX 90609, AUSTIN, TX, 78709-0609, US

(21) Appl. No.: 11/052,502

(22) Filed: Feb. 4, 2005

(51) Int. Cl. G06F 9/30

(52) U.S. Cl. 712/207

(57) ABSTRACT

A system and method that maintains a relatively small Instruction Load Buffer (ILB) is maintained for scheduling instructions. Instructions are sent from Local Store (LS) to the ILB using either an inline prefetcher or a branch table buffer loader. In one embodiment, the prefetcher is a hardware-based prefetcher that fetches, in address order, the next instructions likely to be scheduled. In one embodiment, the predicted branch instructions are loaded as a result of a software program, such as a dispatcher, issuing a “load branch table buffer (loadbtb)” instruction. Predicted branch instructions are loaded in one area of the ILB and inline instructions are loaded in another area of the ILB. In one embodiment, the loadbtb loads the instruction line that includes the predicted branch target address as well as the instruction line that immediately follows the instruction line with the predicted branch target address.

### BACKGROUND OF THE INVENTION

1. Technical Field

The present invention relates in general to prefetched instructions to schedule for execution. More particularly, the present invention relates to maintaining an instruction line buffer that includes both inline lines as well as branch-predict lines.

2. Description of the Related Art

Modern processors have mechanisms to prefetch instructions before they are scheduled for execution. Prefetching instructions allows some instructions to be waiting for execution, rather than having the processor wait for the instructions it needs to be loaded from memory. In this way, a new instruction can often be started as soon as the previous instruction has cleared the first stage in a pipeline. In this manner, multiple instructions can progress through the instruction pipeline simultaneously. This is commonly referred to as “Instruction-Level Parallelism (ILP).”

These prefetched instructions are held in a buffer until they can be sequenced into issue and execution. Instructions can represent the inline execution path or a target path to be reached by a taken branch. Some known techniques for handling both inline and branch instructions include using branch target buffers and trace caches. Branch target buffers are based upon having two separate storage structures for inline data and for target (branch) data. Sequencing is steered toward the target (branch) instructions when an index into the branch target buffer finds a match. When using trace caches, the most likely execution sequence is stored in the cache with the target merged into the sequence after the inline portion. A trace cache will often include a pointer to the next successor in the trace cache.

A challenge of using traditional buffers and caches is twofold. First, as processors become increasingly fast, instructions need to be prefetched more quickly so that they are readily available to the processors. Second, using traditional techniques to prefetch instructions often leads to overly large buffers and caches in order to keep up the processor and prevent stalls.

A related challenge is the penalty for mis-predictions can be quite large if a branch is predicted but is not actually executed. Systems with larger pipelines pay a greater penalty as more instructions need to be flushed from the pipeline.

What is needed, therefore, is a system and method that organizes the prefetch buffer so that it is both small and fast. Furthermore, what is needed is a system and method that maintains state information regarding instructions stored within the prefetch buffer in order to facilitate the speed requirements without requiring large data structures and storage spaces needed to store the prefetched instructions.

### SUMMARY

It has been discovered that the aforementioned challenges are resolved using a system and method that maintains a relatively small Instruction Load Buffer (ILB). Instructions are sent from Local Store (LS) to the ILB using either an inline prefetcher or a branch table buffer loader. In one embodiment, the prefetcher is a hardware-based prefetcher that fetches, in address order, the next instructions likely to be scheduled. In one embodiment, the predicted branch instructions are loaded as a result of a software program, such as a dispatcher, issuing a “load branch table buffer (loadbtb)” instruction.

Predicted branch instructions are loaded in one area of the ILB and inline instructions are loaded in another area of the ILB. In one embodiment, the loadbtb loads the instruction line that includes the predicted branch target address as well as the instruction line that immediately follows the instruction line with the predicted branch target address. In an embodiment using 64 byte lines, each of which stores 16 4-byte instructions, loading the instruction line that includes the predicted branch target address and the succeeding instruction line loads between 17 and 32 instructions.

State information is maintained in order to determine which line within the ILB is the next Current Predicted Path (CPP). When an instruction line is made the CPP, one or more instructions of the CPP are scheduled to Issue Control, depending on the state information. As instruction lines arrive at the ILB, state information (such as pointers and addresses) are updated in order to determine the scheduling order of the lines. In addition, first and last instruction pointers are maintained so that the correct instruction is scheduled when the line becomes the CPP and a new CPP is loaded when the last identified instruction of the CPP is scheduled.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 illustrates—the overall architecture of a computer network in accordance with the present invention;

FIG. 2 is a diagram illustrating the structure of a processing unit (PU) in accordance with the present invention;

FIG. 3 is a diagram illustrating the structure of a broadband engine (BE) in accordance with the present invention;

FIG. 4 is a diagram illustrating the structure of an synergistic processing unit (SPU) in accordance with the present invention;

FIG. 5 is a diagram illustrating the structure of a processing unit, visualizer (VS) and an optical interface in accordance with the present invention;

FIG. 6 is a diagram illustrating one combination of processing units in accordance with the present invention;

FIG. 7 illustrates another combination of processing units in accordance with the present invention;

FIG. 8 illustrates yet another combination of processing units in accordance with the present invention;

FIG. 9 illustrates yet another combination of processing units in accordance with the present invention;

FIG. 10 illustrates yet another combination of processing units in accordance with the present invention;

FIG. 11A illustrates the integration of optical interfaces within a chip package in accordance with the present invention;

FIG. 11B is a diagram of one configuration of processors using the optical interfaces of FIG. 11A;

FIG. 11C is a diagram of another configuration of processors using the optical interfaces of FIG. 11A;

FIG. 12A illustrates the structure of a memory system in accordance with the present invention;

FIG. 12B illustrates the writing of data from a first broadband engine to a second broadband engine in accordance with the present invention;

FIG. 13 is a diagram of the structure of a shared memory for a processing unit in accordance with the present invention;

FIG. 14A illustrates one structure for a bank of the memory shown in FIG. 13;

FIG. 14B illustrates another structure for a bank of the memory shown in FIG. 13;

FIG. 15 illustrates a structure for a direct memory access controller in accordance with the present invention;

FIG. 16 illustrates an alternative structure for a direct memory access controller in accordance with the present invention;

FIGS. 17-31 illustrate the operation of data synchronization in accordance with the present invention;

FIG. 32 is a three-state memory diagram illustrating the various states of a memory location in accordance with the data synchronization scheme of the-present invention;

FIG. 33 illustrates the structure of a key control table for a hardware sandbox in accordance with the present invention;

FIG. 34 illustrates a scheme for storing memory access keys for a hardware sandbox in accordance with the present invention;

FIG. 35 illustrates the structure of a memory access control table for a hardware sandbox in accordance with the present invention;

FIG. 36 is a flow diagram of the steps for accessing a memory sandbox using the key control table of FIG. 33 and the memory access control table of FIG. 35;

FIG. 37 illustrates the structure of a software cell in accordance with the present invention;

FIG. 38 is a flow diagram of the steps for issuing remote procedure calls to SPUs in accordance with the present invention;

FIG. 39 illustrates the structure of a dedicated pipeline for processing streaming data in accordance with the present invention;

FIG. 40 is a flow diagram of the steps performed by the dedicated pipeline of FIG. 39 in the processing of streaming data in accordance with the present invention;

FIG. 41 illustrates an alternative structure for a dedicated pipeline for the processing of streaming data in accordance with the present invention;

FIG. 42 illustrates a scheme for an absolute timer for coordinating the parallel processing of applications and data by SPUs in accordance with the present invention;

FIG. 43 illustrates the organization of the Synergistic Processing Element (SPE);

FIG. 44 illustrates the SPE's unit and instruction latency;

FIG. 45 is a diagram of the SPE pipeline;

FIG. 46 is a photograph of the SPE die;

FIG. 47 is a voltage/frequency schmoo;

FIG. 48 is a diagram of the SPE Instruction Line Buffer (ILB);

FIG. 49 is a state diagram showing scheduling order of lines within the ILB;

FIG. 50 is a diagram showing data loaded from two banks of memory as a result of a software-initiated “load branch table buffer” (loadbtb) instruction;

FIG. 51 is another diagram of data loaded from two banks of memory as a result of the loadbtb instruction;

FIG. 52 is a flowchart showing the logical progression through the lines included in the ILB;

FIG. 53 shows an example progression through the lines included in the ILB when predicted branch target instructions have been loaded;

FIG. 54 shows an example progression through the lines included in the ILB when no predicted branch target instructions have been loaded;

FIG. 55 shows a flowchart detailing steps taken when a new line is loaded in the ILB by either the prefetch hardware or as a result of the loadbtb instruction; and

FIG. 56 is a flowchart detailing steps taken in deciding when to load the next scheduled line from the ILB into the Currently Predicted Path (CPP).

### DETAILED DESCRIPTION

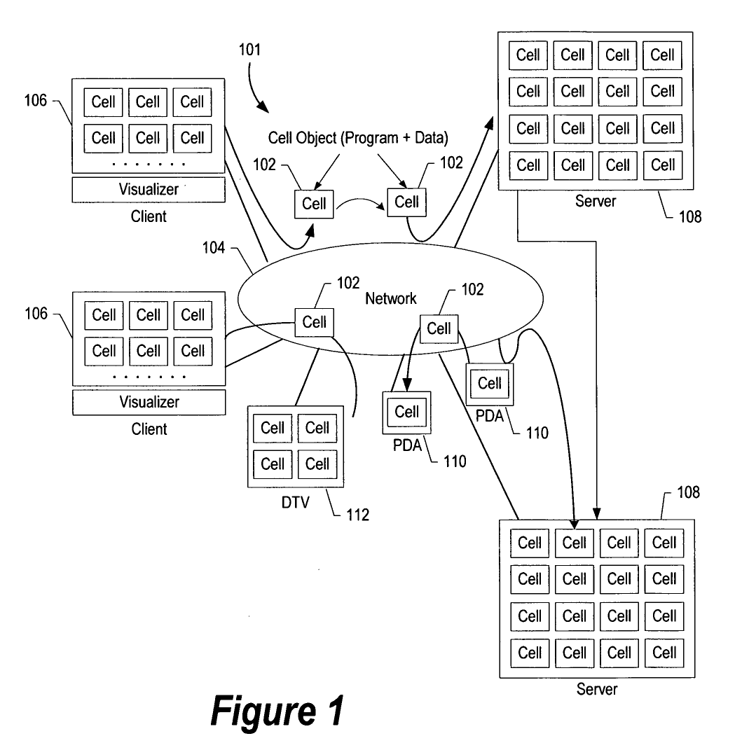

The overall architecture for a computer system 101 in accordance with the present invention is shown in FIG. 1.

As illustrated in this figure, system 101 includes network 104 to which is connected a plurality of computers and computing devices. Network 104 can be a LAN, a global network, such as the Internet, or any other computer network.

The computers and computing devices connected to network 104 (the network's “members”) include, e.g., client computers 106, server computers 108, personal digital assistants (PDAs) 110, digital television (DTV) 112 and other wired or wireless computers and computing devices. The processors employed by the members of network 104 are constructed from the same common computing module. These processors also preferably all have the same ISA and perform processing in accordance with the same instruction set. The number of modules included within any particular processor depends upon the processing power required by that processor.

For example, since servers 108 of system 101 perform more processing of data and applications than clients 106, servers 108 contain more computing modules than clients 106. PDAs 110, on the other hand, perform the least amount of processing. PDAs 110, therefore, contain the smallest number of computing modules. DTV 112 performs a level of processing between that of clients 106 and servers 108. DTV 112, therefore, contains a number of computing modules between that of clients 106 and servers 108. As discussed below, each computing module contains a processing controller and a plurality of identical processing units for performing parallel processing of the data and applications transmitted over network 104.

This homogeneous configuration for system 101 facilitates adaptability, processing speed and processing efficiency. Because each member of system 101 performs processing using one or more (or some fraction) of the same computing module, the particular computer or computing device performing the actual processing of data and applications is unimportant. The processing of a particular application and data, moreover, can be shared among the network's members. By uniquely identifying the cells comprising the data and applications processed by system 101 throughout the system, the processing results can be transmitted to the computer or computing device requesting the processing regardless of where this processing occurred. Because the modules performing this processing have a common structure and employ a common ISA, the computational burdens of an added layer of software to achieve compatibility among the processors is avoided. This architecture and programming model facilitates the processing speed necessary to execute, e.g., real-time, multimedia applications.

To take further advantage of the processing speeds and efficiencies facilitated by system 101, the data and applications processed by this system are packaged into uniquely identified, uniformly formatted software cells 102. Each software cell 102 contains, or can contain, both applications and data. Each software cell also contains an ID to globally identify the cell throughout network 104 and system 101. This uniformity of structure for the software cells, and the software cells' unique identification throughout the network, facilitates the processing of applications and data on any computer or computing device of the network. For example, a client 106 may formulate a software cell 102 but, because of the limited processing capabilities of client 106, transmit this software cell to a server 108 for processing. Software cells can migrate, therefore, throughout network 104 for processing on the basis of the availability of processing resources on the network.

The homogeneous structure of processors and software cells of system 101 also avoids many of the problems of today's heterogeneous networks. For example, inefficient programming models which seek to permit processing of applications on any ISA using any instruction set, e.g., virtual machines such as the Java virtual machine, are avoided. System 101, therefore, can implement broadband processing far more effectively and efficiently than today's networks.

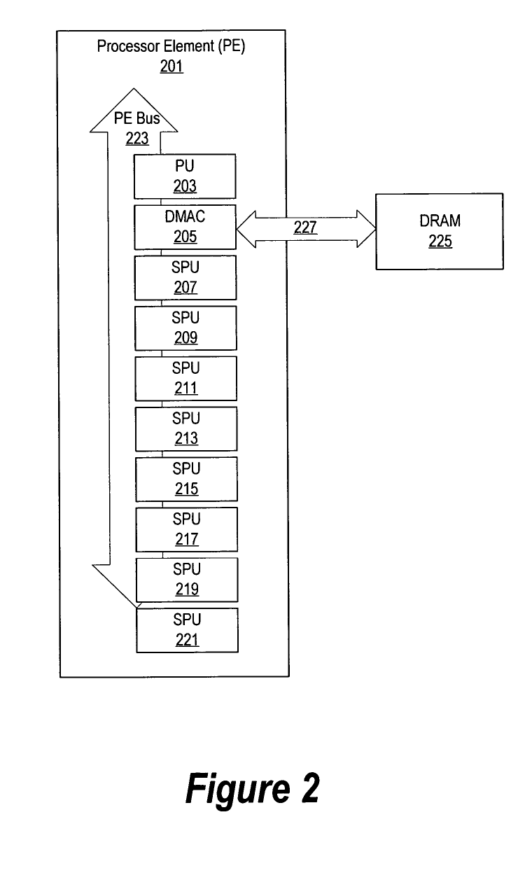

The basic processing module for all members of network 104 is the processing unit (PU). FIG. 2 illustrates the structure of a PU. As shown in this figure, PE 201 comprises a processing unit (PU) 203, a direct memory access controller (DMAC) 205 and a plurality of synergistic processing units (SPUs), namely, SPU 207, SPU 209, SPU 211, SPU 213, SPU 215, SPU 217, SPU 219 and SPU 221. A local PE bus 223 transmits data and applications among the SPUs, DMAC 205 and PU 203. Local PE bus 223 can have, e.g., a conventional architecture or be implemented as a packet switch network. Implementation as a packet switch network, while requiring more hardware, increases available bandwidth.

PE 201 can be constructed using various methods for implementing digital logic. PE 201 preferably is constructed, however, as a single integrated circuit employing a complementary metal oxide semiconductor (CMOS) on a silicon substrate. Alternative materials for substrates include gallium arsinide, gallium aluminum arsinide and other so-called III-B compounds employing a wide variety of dopants. PE 201 also could be implemented using superconducting material, e.g., rapid single-flux-quantum (RSFQ) logic.

PE 201 is closely associated with a dynamic random access memory (DRAM) 225 through a high bandwidth memory connection 227. DRAM 225 functions as the main memory for PE 201. Although a DRAM 225 preferably is a dynamic random access memory, DRAM 225 could be implemented using other means, e.g., as a static random access memory (SRAM), a magnetic random access memory (MRAM), an optical memory or a holographic memory. DMAC 205 facilitates the transfer of data between DRAM 225 and the SPUs and PU of PE 201. As further discussed below, DMAC 205 designates for each SPU an exclusive area in DRAM 225 into which only the SPU can write data and from which only the SPU can read data. This exclusive area is designated a “sandbox.”

PU 203 can be, e.g., a standard processor capable of stand-alone processing of data and applications. In operation, PU 203 schedules and orchestrates the processing of data and applications by the SPUs. The SPUs preferably are single instruction, multiple data (SIMD) processors. Under the control of PU 203, the SPUs perform the processing of these data and applications in a parallel and independent manner. DMAC 205 controls accesses by PU 203 and the SPUs to the data and applications stored in the shared DRAM 225. Although PE 201 preferably includes eight SPUs, a greater or lesser number of SPUs can be employed in a PU depending upon the processing power required. Also, a number of PUs, such as PE 201, may be joined or packaged together to provide enhanced processing power.

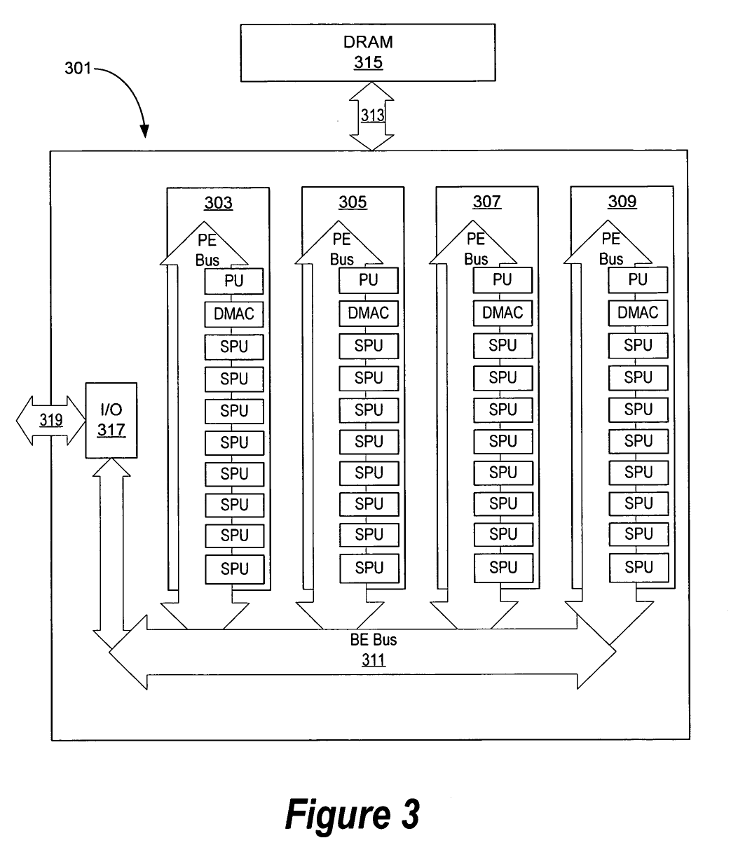

For example, as shown in FIG. 3, four PUs may be packaged or joined together, e.g., within one or more chip packages, to form a single processor for a member of network 104. This configuration is designated a broadband engine (BE). As shown in FIG. 3, BE 301 contains four PUs, namely, PE 303, PE 305, PE 307 and PE 309. Communications among these PUs are over BE bus 311. Broad bandwidth memory connection 313 provides communication between shared DRAM 315 and these PUs. In lieu of BE bus 311, communications among the PUs of BE 301 can occur through DRAM 315 and this memory connection.

Input/output (I/O) interface 317 and external bus 319 provide communications between broadband engine 301 and the other members of network 104. Each PU of BE 301 performs processing of data and applications in a parallel and independent manner analogous to the parallel and independent processing of applications and data performed by the SPUs of a PU.

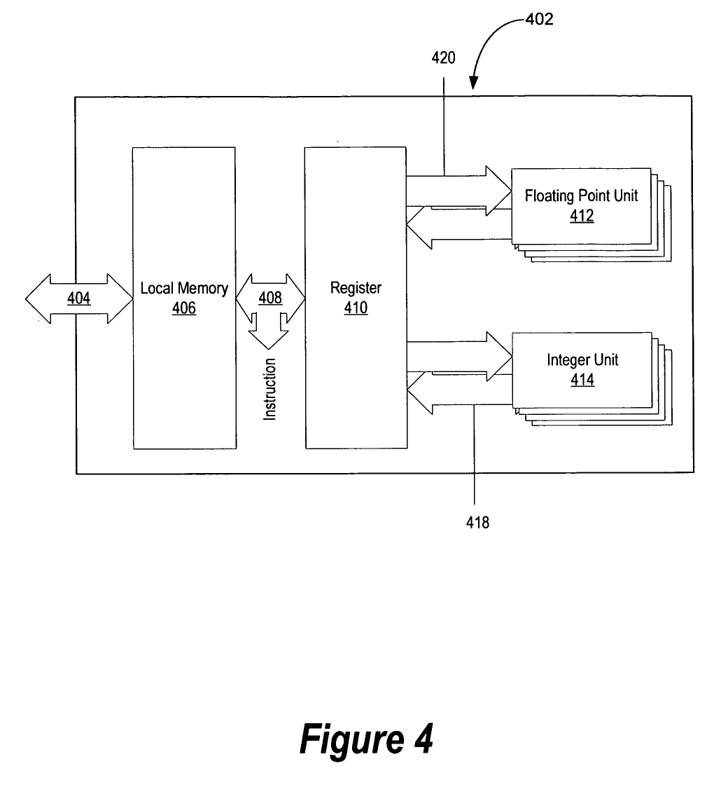

FIG. 4 illustrates the structure of an SPU. SPU 402 includes local memory 406, registers 410, four floating point units 412 and four integer units 414. Again, however, depending upon the processing power required, a greater or lesser number of floating points units 412 and integer units 414 can be employed. In a preferred embodiment, local memory 406 contains 128 kilobytes of storage, and the capacity of registers 410 is 128.times.128 bits. Floating point units 412 preferably operate at a speed of 32 billion floating point operations per second (32 GFLOPS), and integer units 414 preferably operate at a speed of 32 billion operations per second (32 GOPS).

Local memory 406 is not a cache memory. Local memory 406 is preferably constructed as an SRAM. Cache coherency support for an SPU is unnecessary. A PU may require cache coherency support for direct memory accesses initiated by the PU. Cache coherency support is not required, however, for direct memory accesses initiated by an SPU or for accesses from and to external devices.

SPU 402 further includes bus 404 for transmitting applications and data to and from the SPU. In a preferred embodiment, this bus is 1,024 bits wide. SPU 402 further includes internal busses 408, 420 and 418. In a preferred embodiment, bus 408 has a width of 256 bits and provides communications between local memory 406 and registers 410. Busses 420 and 418 provide communications between, respectively, registers 410 and floating point units 412, and registers 410 and integer units 414. In a preferred embodiment, the width of busses 418 and 420 from registers 410 to the floating point or integer units is 384 bits, and the width of busses 418 and 420 from the floating point or integer units to registers 410 is 128 bits. The larger width of these busses from registers 410 to the floating point or integer units than from these units to registers 410 accommodates the larger data flow from registers 410 during processing. A maximum of three words are needed for each calculation. The result of each calculation, however, normally is only one word.

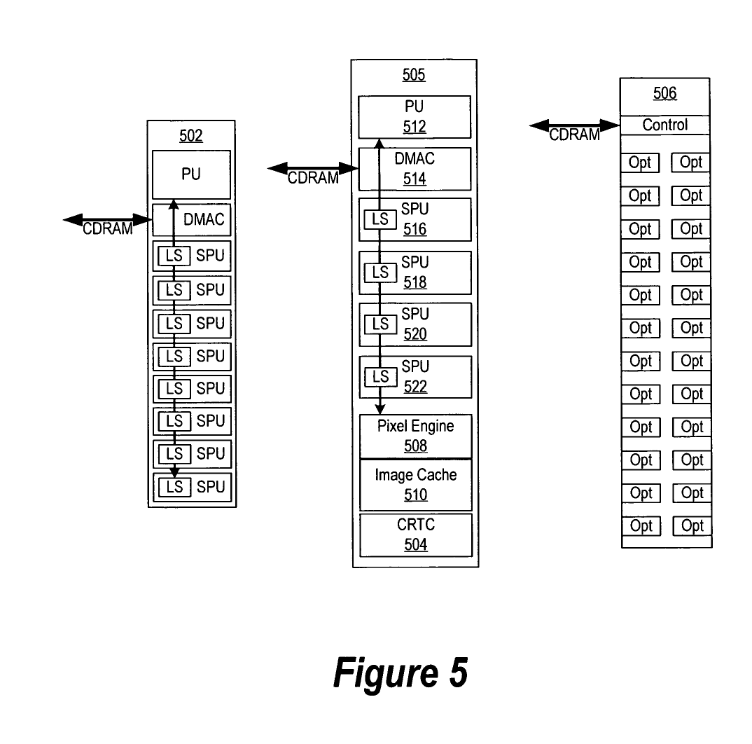

FIGS. 5-10 further illustrate the modular structure of the processors of the members of network 104. For example, as shown in FIG. 5, a processor may comprise a single PU 502. As discussed above, this PU typically comprises a PU, DMAC and eight SPUs. Each SPU includes local storage (LS) . On the other hand, a processor may comprise the structure of visualizer (VS) 505. As shown in FIG. 5, VS 505 comprises PU 512, DMAC 514 and four SPUs, namely, SPU 516, SPU 518, SPU 520 and SPU 522. The space within the chip package normally occupied by the other four SPUs of a PU is occupied in this case by pixel engine 508, image cache 510 and cathode ray tube controller (CRTC) 504. Depending upon the speed of communications required for PU 502 or VS 505, optical interface 506 also may be included on the chip package.

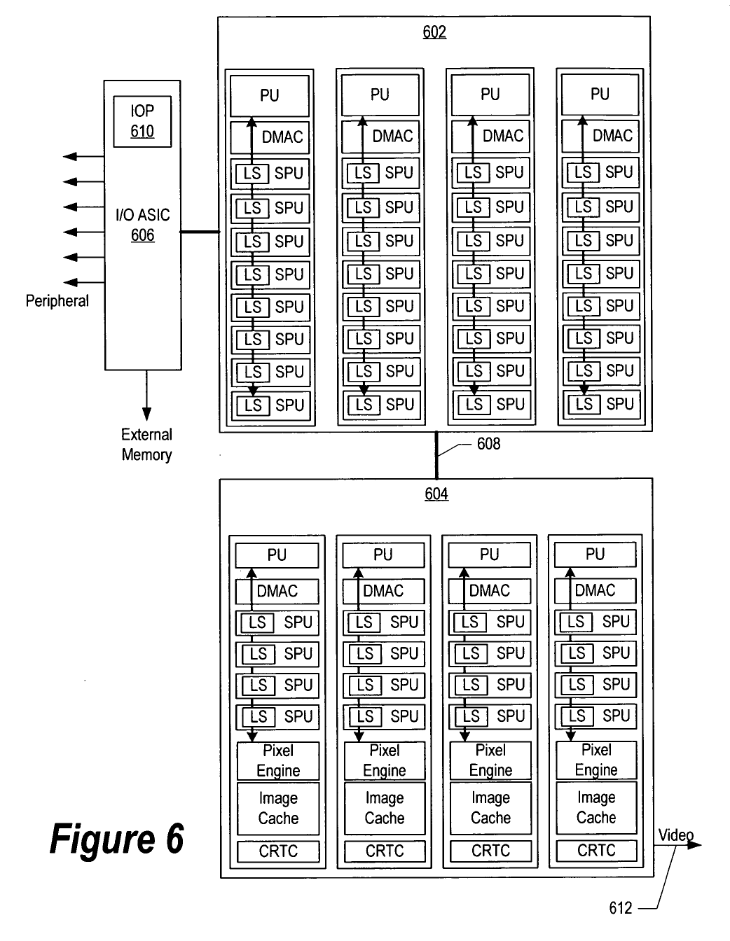

Using this standardized, modular structure, numerous other variations of processors can be constructed easily and efficiently. For example, the processor shown in FIG. 6 comprises two chip packages, namely, chip package 602 comprising a BE and chip package 604 comprising four VSs. Input/output (I/O) 606 provides an interface between the BE of chip package 602 and network 104. Bus 608 provides communications between chip package 602 and chip package 604. Input output processor (IOP) 610 controls the flow of data into and out of I/O 606. I/O 606 may be fabricated as an application specific integrated circuit (ASIC). The output from the VSs is video signal 612.

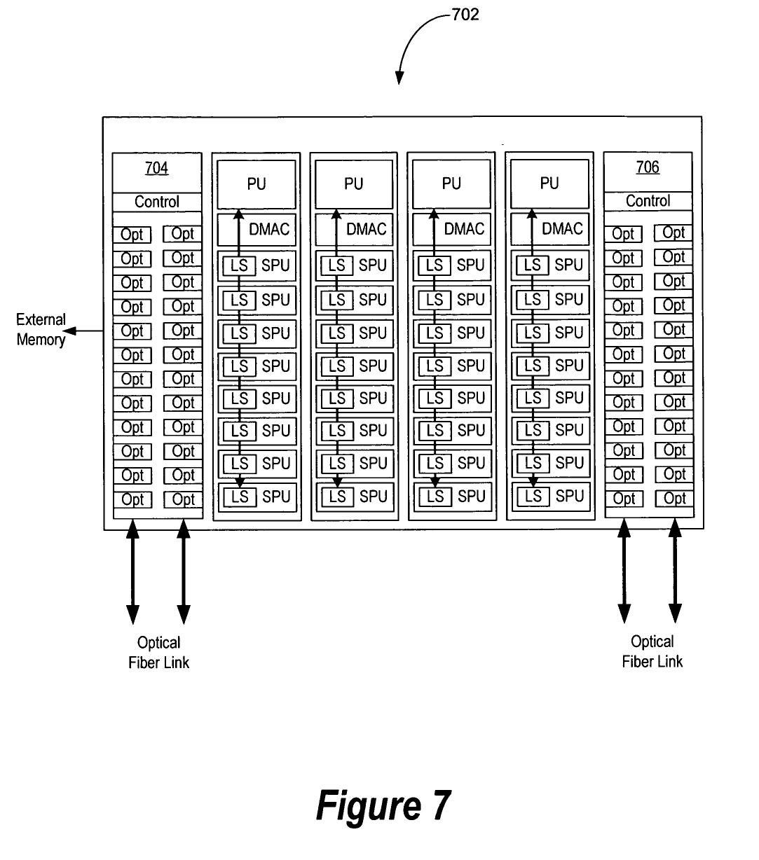

FIG. 7 illustrates a chip package for a BE 702 with two optical interfaces 704 and 706 for providing ultra high speed communications to the other members of network 104 (or other chip packages locally connected). BE 702 can function as, e.g., a server on network 104.

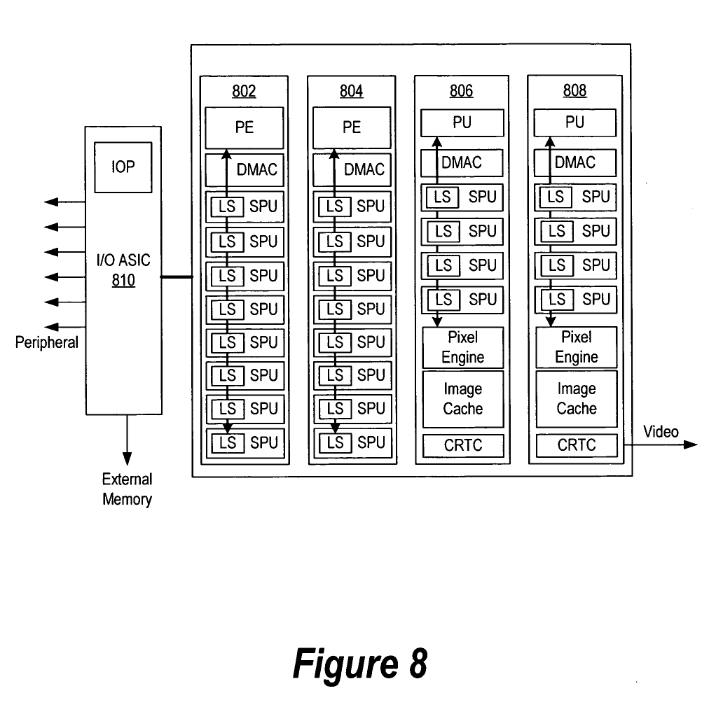

The chip package of FIG. 8 comprises two PEs 802 and 804 and two VSs 806 and 808. An I/O 810 provides an interface between the chip package and network 104. The output from the chip package is a video signal. This configuration may function as, e.g., a graphics work station.

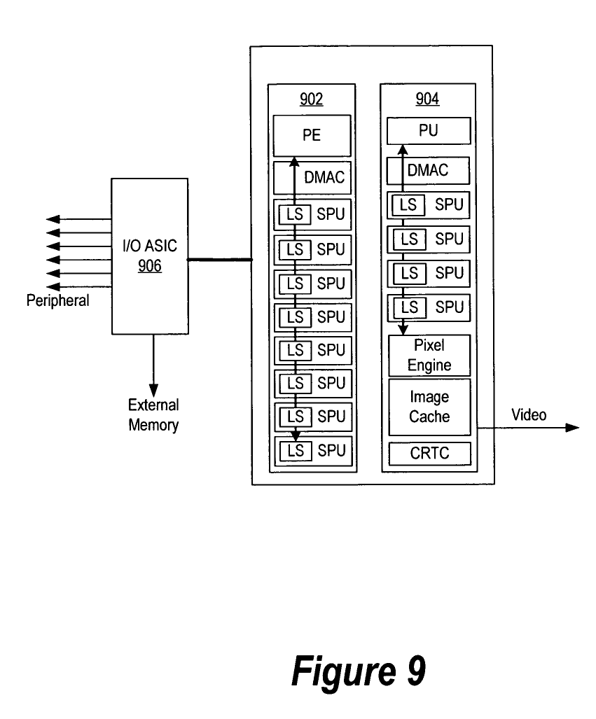

FIG. 9 illustrates yet another configuration. This configuration contains one-half of the processing power of the configuration illustrated in FIG. 8. Instead of two PUs, one PE 902 is provided, and instead of two VSs, one VS 904 is provided. I/O 906 has one-half the bandwidth of the I/O illustrated in FIG. 8. Such a processor also may function, however, as a graphics work station.

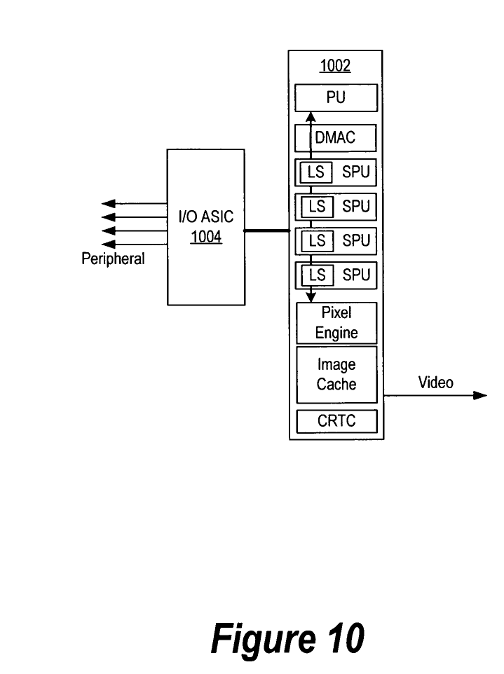

A final configuration is shown in FIG. 10. This processor consists of only a single VS 1002 and an I/O 1004. This configuration may function as, e.g., a PDA.

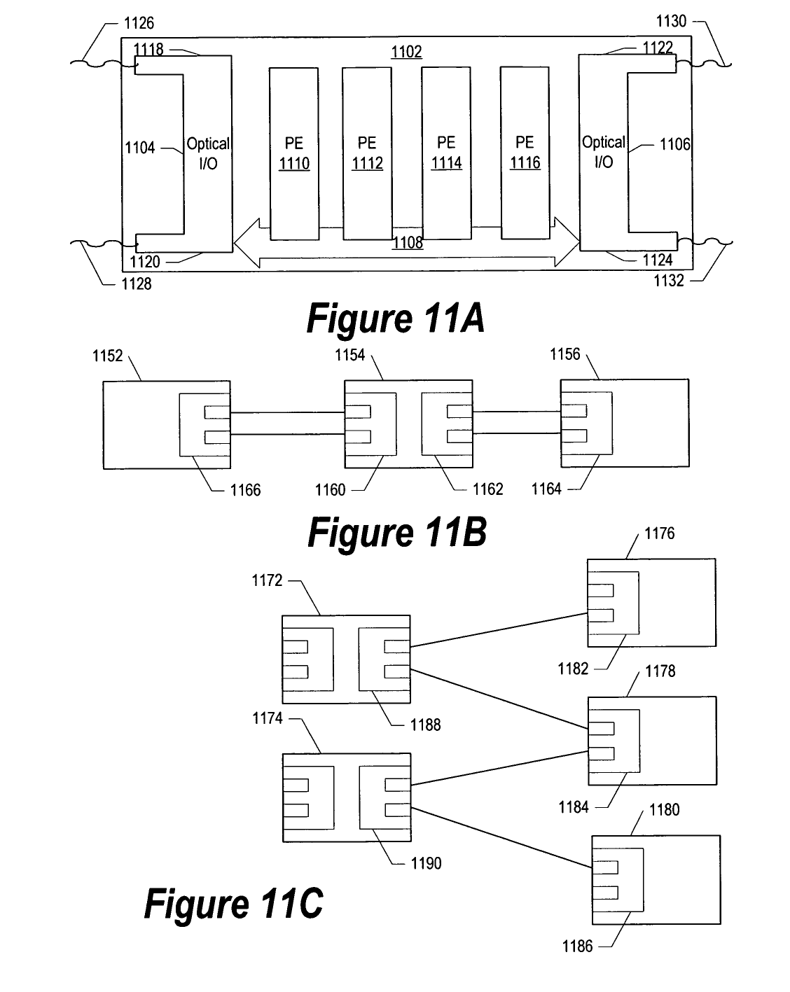

FIG. 11A illustrates the integration of optical interfaces into a chip package of a processor of network 104. These optical interfaces convert optical signals to electrical signals and electrical signals to optical signals and can be constructed from a variety of materials including, e.g., gallium arsinide, aluminum gallium arsinide, germanium and other elements or compounds. As shown in this figure, optical interfaces 1104 and 1106 are fabricated on the chip package of BE 1102. BE bus 1108 provides communication among the PUs of BE 1102, namely, PE 1110, PE 1112, PE 1114, PE 1116, and these optical interfaces. Optical interface 1104 includes two ports, namely, port 1118 and port 1120, and optical interface 1106 also includes two ports, namely, port 1122 and port 1124. Ports 1118, 1120, 1122 and 1124 are connected to, respectively, optical wave guides 1126, 1128, 1130 and 1132. Optical signals are transmitted to and from BE 1102 through these optical wave guides via the ports of optical interfaces 1104 and 1106.

plurality of BEs can be connected together in various configurations using such optical wave guides and the four optical ports of each BE. For example, as shown in FIG. 11B, two or more BEs, e.g., BE 1152, BE 1154 and BE 1156, can be connected serially through such optical ports. In this example, optical interface 1166 of BE 1152 is connected through its optical ports to the optical ports of optical interface 1160 of BE 1154. In a similar manner, the optical ports of optical interface 1162 on BE 1154 are connected to the optical ports of optical interface 1164 of BE 1156.

A matrix configuration is illustrated in FIG. 11C. In this configuration, the optical interface of each BE is connected to two other BEs. As shown in this figure, one of the optical ports of optical interface 1188 of BE 1172 is connected to an optical port of optical interface 1182 of BE 1176. The other optical port of optical interface 1188 is connected to an optical port of optical interface 1184 of BE 1178. In a similar manner, one optical port of optical interface 1190 of BE 1174 is connected to the other optical port of optical interface 1184 of BE 1178. The other optical port of optical interface 1190 is connected to an optical port of optical interface 1186 of BE 1180. This matrix configuration can be extended in a similar manner to other BEs.

Using either a serial configuration or a matrix configuration, a processor for network 104 can be constructed of any desired size and power. Of course, additional ports can be added to the optical interfaces of the BEs, or to processors having a greater or lesser number of PUs than a BE, to form other configurations.

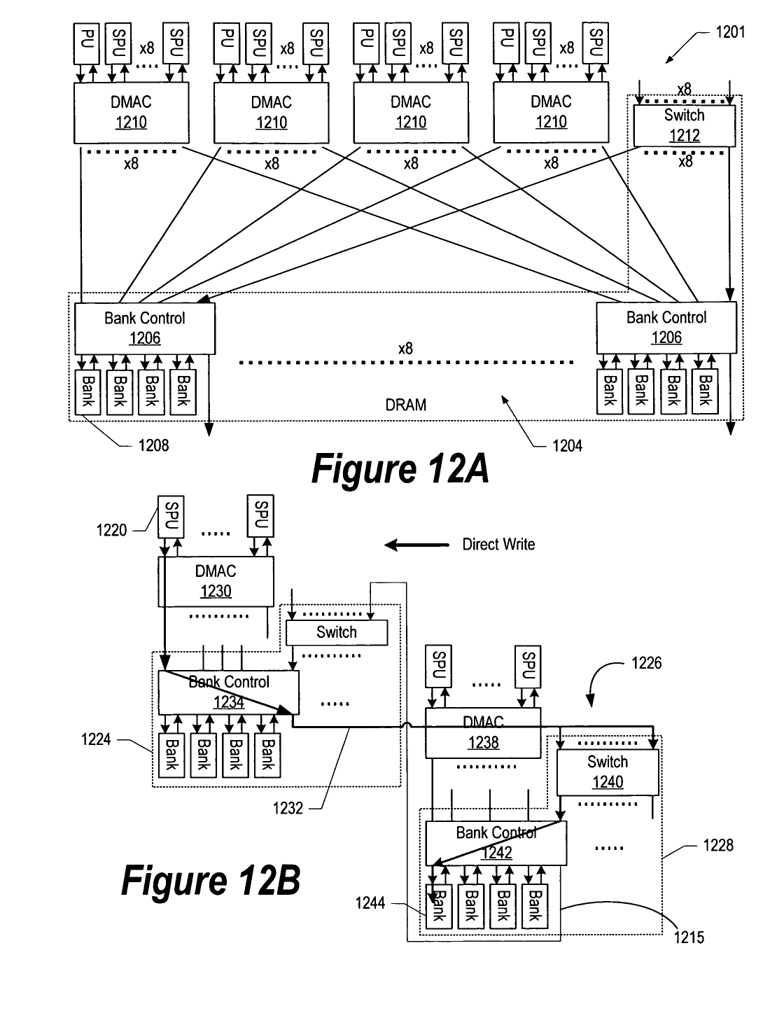

FIG. 12A illustrates the control system and structure for the DRAM of a BE. A similar control system and structure is employed in processors having other sizes and containing more or less PUs. As shown in this figure, a cross-bar switch connects each DMAC 1210 of the four PUs comprising BE 1201 to eight bank controls 1206. Each bank control 1206 controls eight banks 1208 (only four are shown in the figure) of DRAM 1204. DRAM 1204, therefore, comprises a total of sixty-four banks. In a preferred embodiment, DRAM 1204 has a capacity of 64 megabytes, and each bank has a capacity of 1 megabyte. The smallest addressable unit within each bank, in this preferred embodiment, is a block of 1024 bits.

BE 1201 also includes switch unit 1212. Switch unit 1212 enables other SPUs on BEs closely coupled to BE 1201 to access DRAM 1204. A second BE, therefore, can be closely coupled to a first BE, and each SPU of each BE can address twice the number of memory locations normally accessible to an SPU. The direct reading or writing of data from or to the DRAM of a first BE from or to the DRAM of a second BE can occur through a switch unit such as switch unit 1212.

For example, as shown in FIG. 12B, to accomplish such writing, the SPU of a first BE, e.g., SPU 1220 of BE 1222, issues a write command to a memory location of a DRAM of a second BE, e.g., DRAM 1228 of BE 1226 (rather than, as in the usual case, to DRAM 1224 of BE 1222). DMAC 1230 of BE 1222 sends the write command through cross-bar switch 1221 to bank control 1234, and bank control 1234 transmits the command to an external port 1232 connected to bank control 1234. DMAC 1238 of BE 1226 receives the write command and transfers this command to switch unit 1240 of BE 1226. Switch unit 1240 identifies the DRAM address contained in the write command and sends the data for storage in this address through bank control 1242 of BE 1226 to bank 1244 of DRAM 1228. Switch unit 1240, therefore, enables both DRAM 1224 and DRAM 1228 to function as a single memory space for the SPUs of BE 1226.

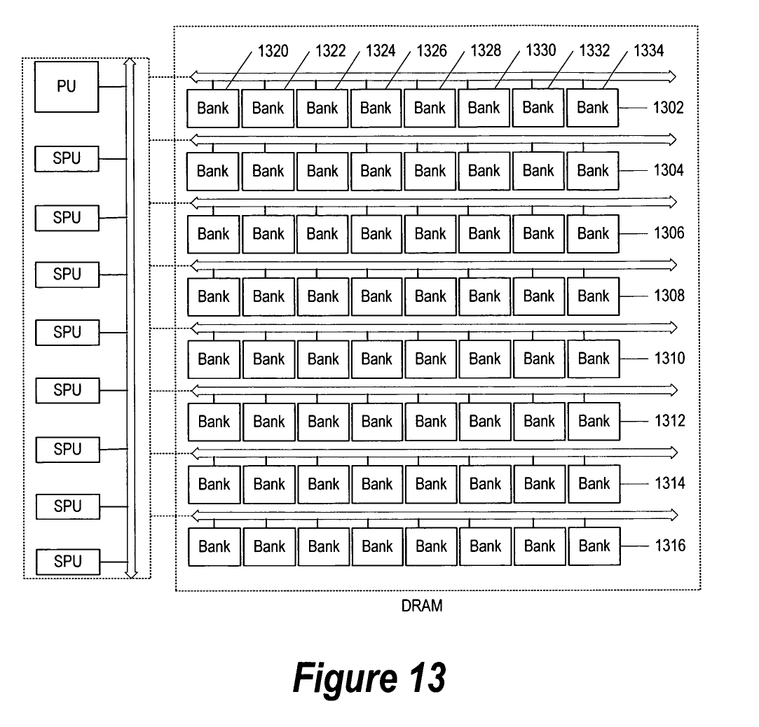

FIG. 13 shows the configuration of the sixty-four banks of a DRAM. These banks are arranged into eight rows, namely, rows 1302, 1304, 1306, 1308, 1310, 1312, 1314 and 1316 and eight columns, namely, columns 1320, 1322, 1324, 1326, 1328, 1330, 1332 and 1334. Each row is controlled by a bank controller. Each bank controller, therefore, controls eight megabytes of memory.

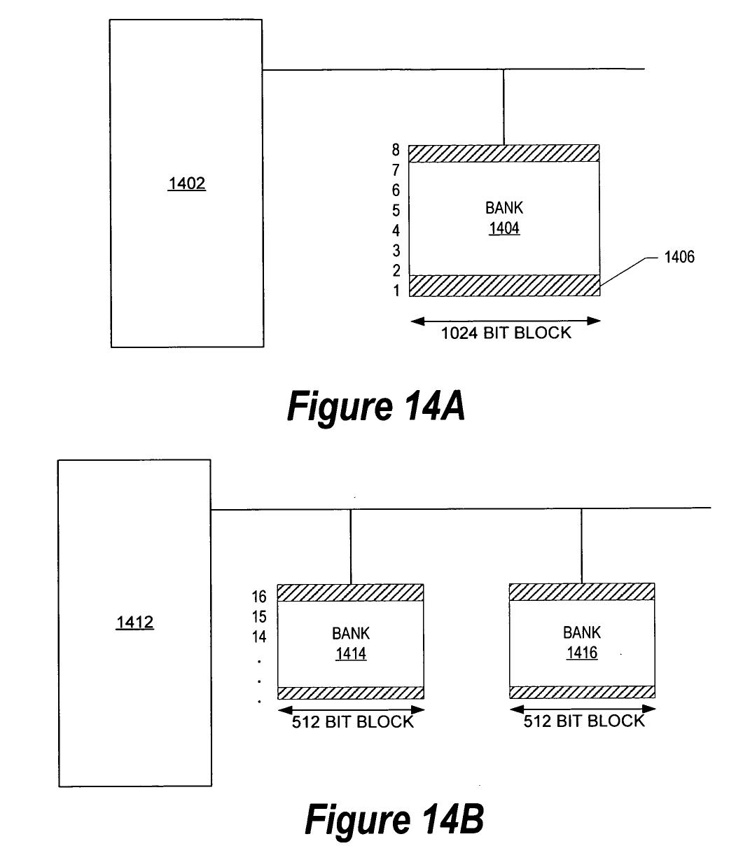

FIGS. 14A and 14B illustrate different configurations for storing and accessing the smallest addressable memory unit of a DRAM, e.g., a block of 1024 bits. In FIG. 14A, DMAC 1402 stores in a single bank 1404 eight 1024 bit blocks 1406. In FIG. 14B, on the other hand, while DMAC 1412 reads and writes blocks of data containing 1024 bits, these blocks are interleaved between two banks, namely, bank 1414 and bank 1416. Each of these banks, therefore, contains sixteen blocks of data, and each block of data contains 512 bits. This interleaving can facilitate faster accessing of the DRAM and is useful in the processing of certain applications.

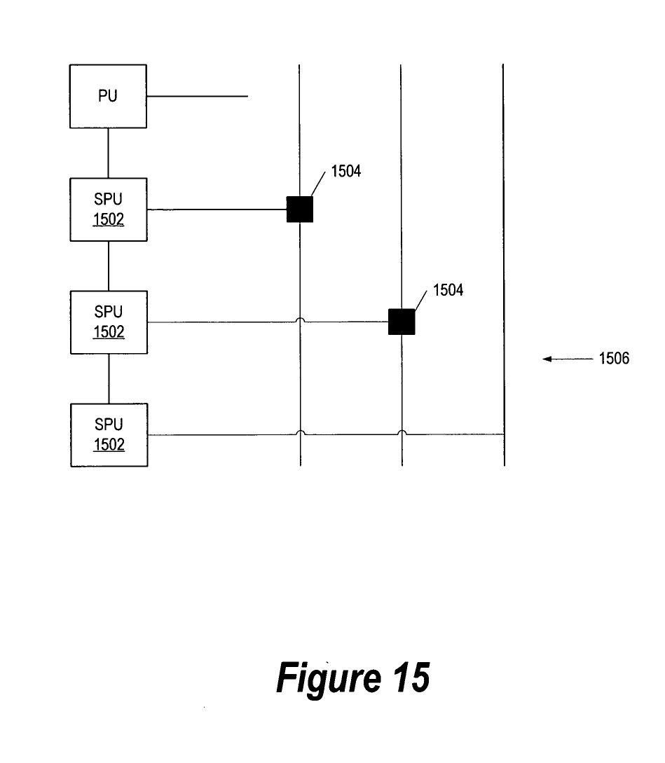

FIG. 15 illustrates the architecture for a DMAC 1504 within a PE. As illustrated in this figure, the structural hardware comprising DMAC 1506 is distributed throughout the PE such that each SPU 1502 has direct access to a structural node 1504 of DMAC 1506. Each node executes the logic appropriate for memory accesses by the SPU to which the node has direct access.

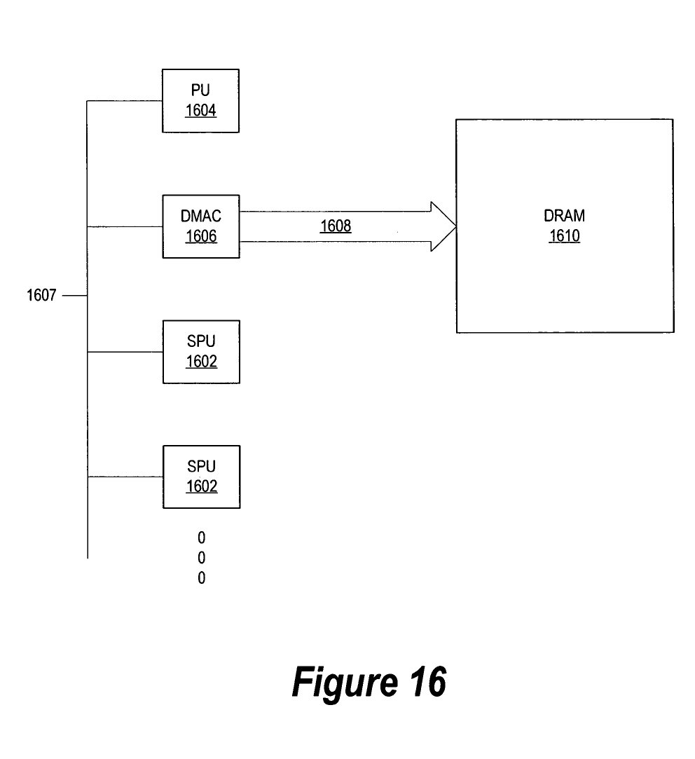

FIG. 16 shows an alternative embodiment of the DMAC, namely, a non-distributed architecture. In this case, the structural hardware of DMAC 1606 is centralized. SPUs 1602 and PU 1604 communicate with DMAC 1606 via local PE bus 1607. DMAC 1606 is connected through a cross-bar switch to a bus 1608. Bus 1608 is connected to DRAM 1610.

As discussed above, all of the multiple SPUs of a PU can independently access data in the shared DRAM. As a result, a first SPU could be operating upon particular data in its local storage at a time during which a second SPU requests these data. If the data were provided to the second SPU at that time from the shared DRAM, the data could be invalid because of the first SPU's ongoing processing which could change the data's value. If the second processor received the data from the shared DRAM at that time, therefore, the second processor could generate an erroneous result. For example, the data could be a specific value for a global variable. If the first processor changed that value during its processing, the second processor would receive an outdated value. A scheme is necessary, therefore, to synchronize the SPUs' reading and writing of data from and to memory locations within the shared DRAM. This scheme must prevent the reading of data from a memory location upon which another SPU currently is operating in its local storage and, therefore, which are not current, and the writing of data into a memory location storing current data.

To overcome these problems, for each addressable memory location of the DRAM, an additional segment of memory is allocated in the DRAM for storing status information relating to the data stored in the memory location. This status information includes a full/empty (F/E) bit, the identification of an SPU (SPU ID) requesting data from the memory location and the address of the SPU's local storage (LS address) to which the requested data should be read. An addressable memory location of the DRAM can be of any size. In a preferred embodiment, this size is 1024 bits.

The setting of the F/E bit to 1 indicates that the data stored in the associated memory location are current. The setting of the F/E bit to 0, on the other hand, indicates that the data stored in the associated memory location are not current. If an SPU requests the data when this bit is set to 0, the SPU is prevented from immediately reading the data. In this case, an SPU ID identifying the SPU requesting the data, and an LS address identifying the memory location within the local storage of this SPU to which the data are to be read when the data become current, are entered into the additional memory segment.

An additional memory segment also is allocated for each memory location within the local storage of the SPUs. This additional memory segment stores one bit, designated the “busy bit.” The busy bit is used to reserve the associated LS memory location for the storage of specific data to be retrieved from the DRAM. If the busy bit is set to 1 for a particular memory location in local storage, the SPU can use this memory location only for the writing of these specific data. On the other hand, if the busy bit is set to 0 for a particular memory location in local storage, the SPU can use this memory location for the writing of any data.

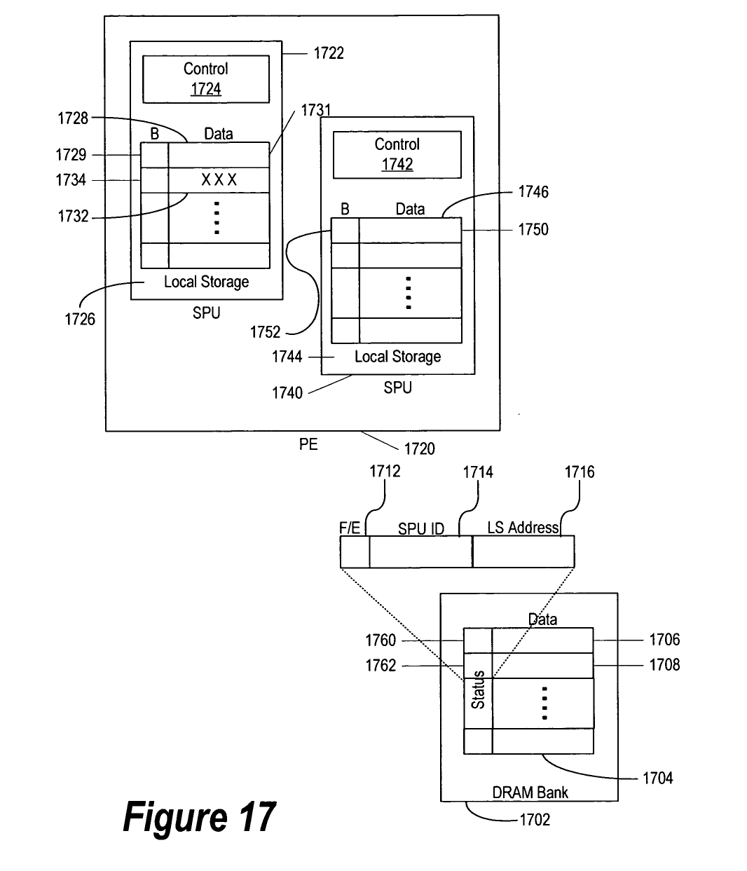

Examples of the manner in which the F/E bit, the SPU ID, the LS address and the busy bit are used to synchronize the reading and writing of data from and to the shared DRAM of a PU are illustrated in FIGS. 17-31.

As shown in FIG. 17, one or more PUs, e.g., PE 1720, interact with DRAM 1702. PE 1720 includes SPU 1722 and SPU 1740. SPU 1722 includes control logic 1724, and SPU 1740 includes control logic 1742. SPU 1722 also includes local storage 1726. This local storage includes a plurality of addressable memory locations 1728. SPU 1740 includes local storage 1744, and this local storage also includes a plurality of addressable memory locations 1746. All of these addressable memory locations preferably are 1024 bits in size.

An additional segment of memory is associated with each LS addressable memory location. For example, memory segments 1729 and 1734 are associated with, respectively, local memory locations 1731 and 1732, and memory segment 1752 is associated with local memory location 1750. A “busy bit,” as discussed above, is stored in each of these additional memory segments. Local memory location 1732 is shown with several Xs to indicate that this location contains data.

DRAM 1702 contains a plurality of addressable memory locations 1704, including memory locations 1706 and 1708. These memory locations preferably also are 1024 bits in size. An additional segment of memory also is associated with each of these memory locations. For example, additional memory segment 1760 is associated with memory location 1706, and additional memory segment 1762 is associated with memory location 1708. Status information relating to the data stored in each memory location is stored in the memory segment associated with the memory location. This status information includes, as discussed above, the F/E bit, the SPU ID and the LS address. For example, for memory location 1708, this status information includes F/E bit 1712, SPU ID 1714 and LS address 1716.

Using the status information and the busy bit, the synchronized reading and writing of data from and to the shared DRAM among the SPUs of a PU, or a group of PUs, can be achieved.

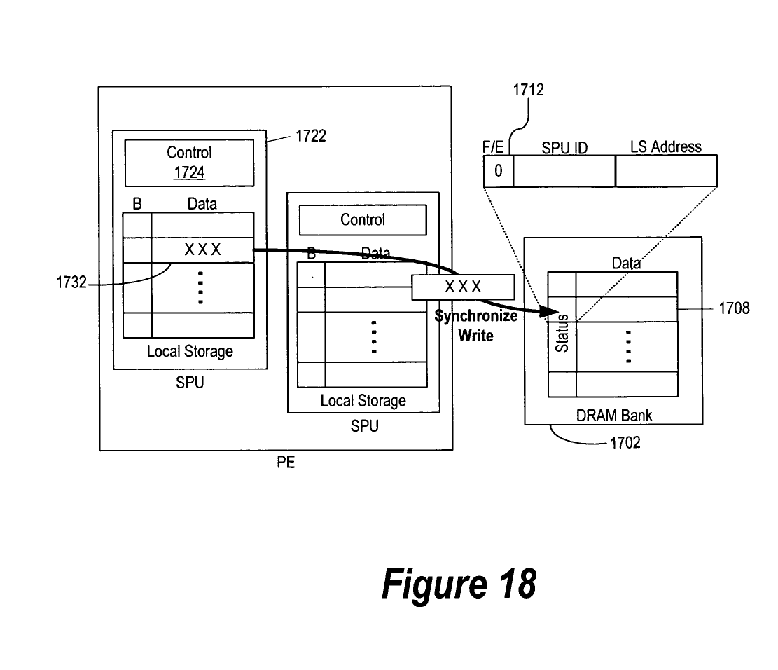

FIG. 18 illustrates the initiation of the synchronized writing of data from LS memory location 1732 of SPU 1722 to memory location 1708 of DRAM 1702. Control 1724 of SPU 1722 initiates the synchronized writing of these data. Since memory location 1708 is empty, F/E bit 1712 is set to 0. As a result, the data in LS location 1732 can be written into memory location 1708. If this bit were set to 1 to indicate that memory location 1708 is full and contains current, valid data, on the other hand, control 1722 would receive an error message and be prohibited from writing data into this memory location.

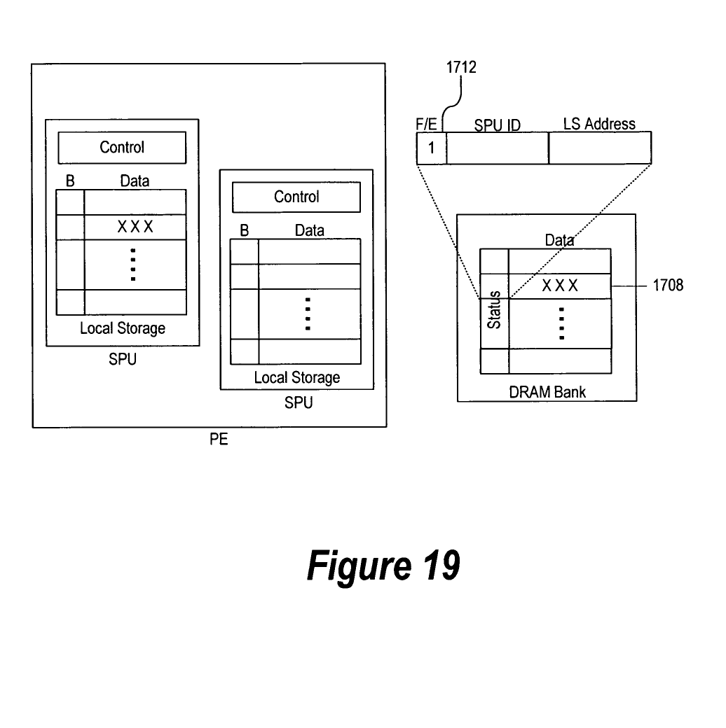

The result of the successful synchronized writing of the data into memory location 1708 is shown in FIG. 19. The written data are stored in memory location 1708, and F/E bit 1712 is set to 1. This setting indicates that memory location 1708 is full and that the data in this memory location are current and valid.

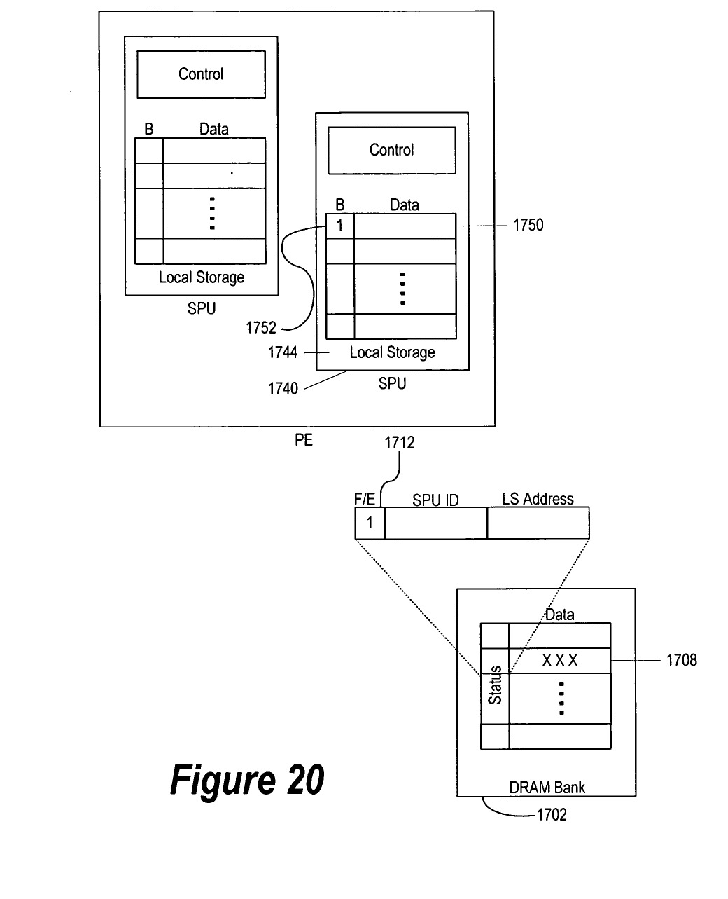

FIG. 20 illustrates the initiation of the synchronized reading of data from memory location 1708 of DRAM 1702 to LS memory location 1750 of local storage 1744. To initiate this reading, the busy bit in memory segment 1752 of LS memory location 1750 is set to 1 to reserve this memory location for these data. The setting of this busy bit to 1 prevents SPU 1740 from storing other data in this memory location.

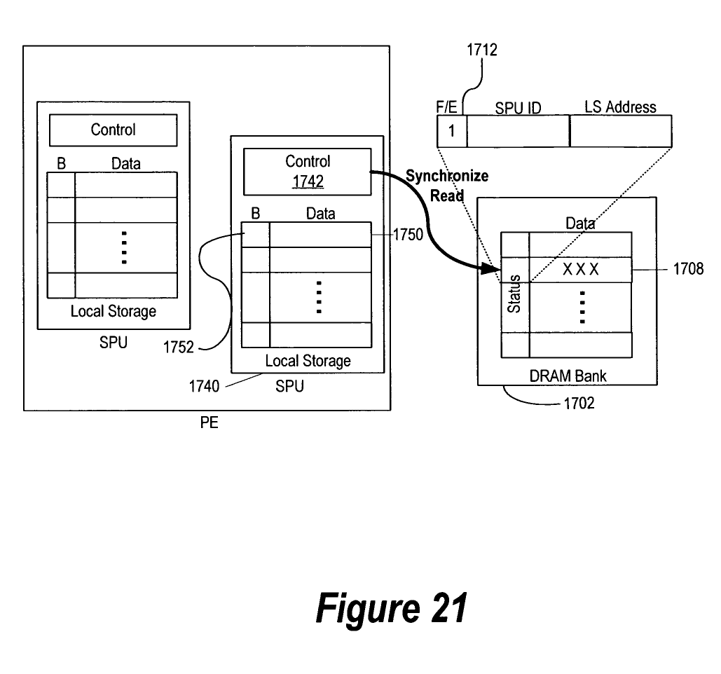

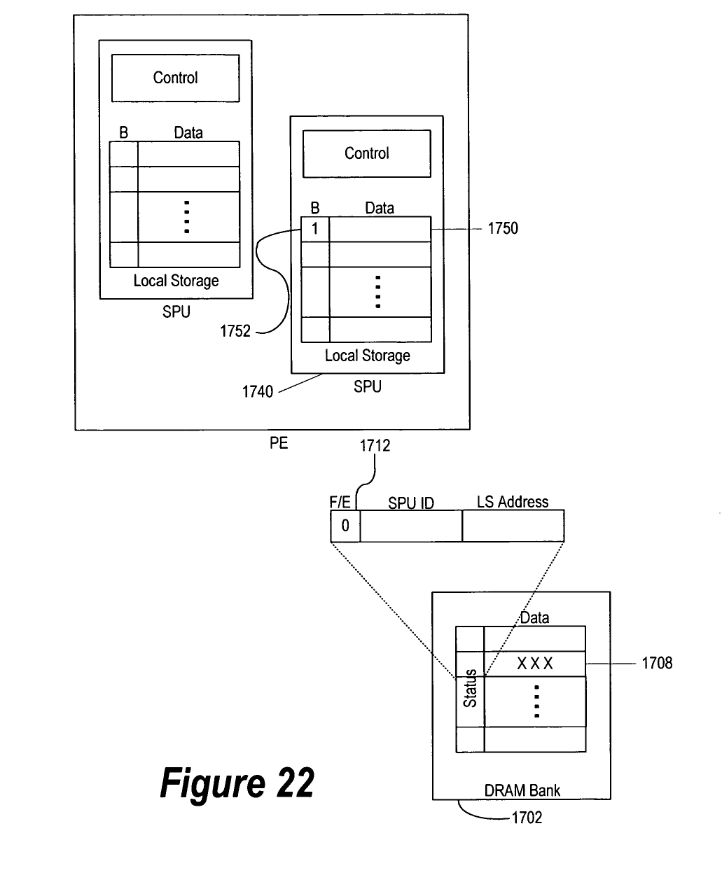

As shown in FIG. 21, control logic 1742 next issues a synchronize read command for memory location 1708 of DRAM 1702. Since F/E bit 1712 associated with this memory location is set to 1, the data stored in memory location 1708 are considered current and valid. As a result, in preparation for transferring the data from memory location 1708 to LS memory location 1750, F/E bit 1712 is set to 0. This setting is shown in FIG. 22. The setting of this bit to 0 indicates that, following the reading of these data, the data in memory location 1708 will be invalid.

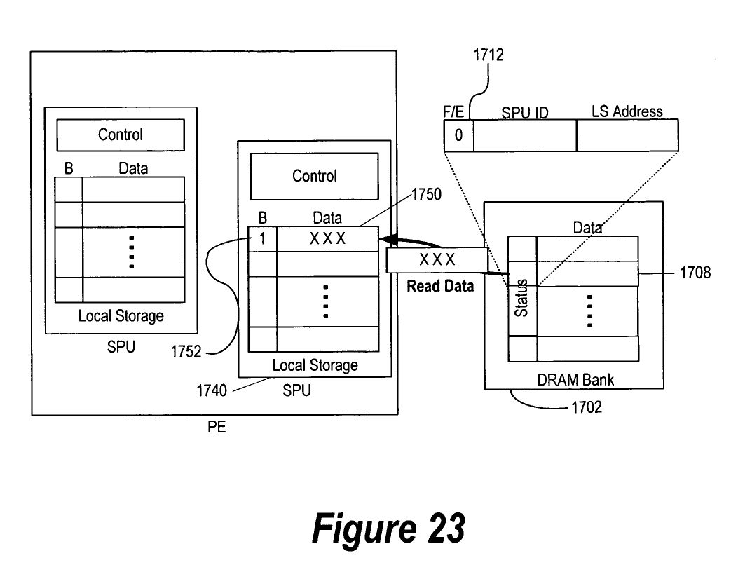

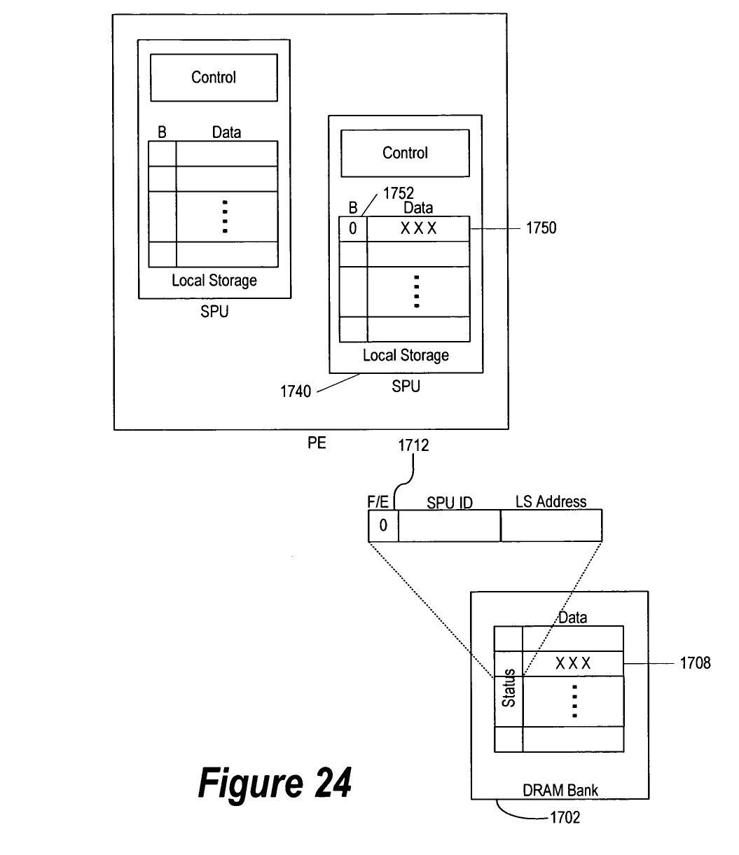

As shown in FIG. 23, the data within memory location 1708 next are read from memory location 1708 to LS memory location 1750. FIG. 24 shows the final state. A copy of the data in memory location 1708 is stored in LS memory location 1750. F/E bit 1712 is set to 0 to indicate that the data in memory location 1708 are invalid. This invalidity is the result of alterations to these data to be made by SPU 1740. The busy bit in memory segment 1752 also is set to 0. This setting indicates that LS memory location 1750 now is available to SPU 1740 for any purpose, i.e., this LS memory location no longer is in a reserved state waiting for the receipt of specific data. LS memory location 1750, therefore, now can be accessed by SPU 1740 for any purpose.

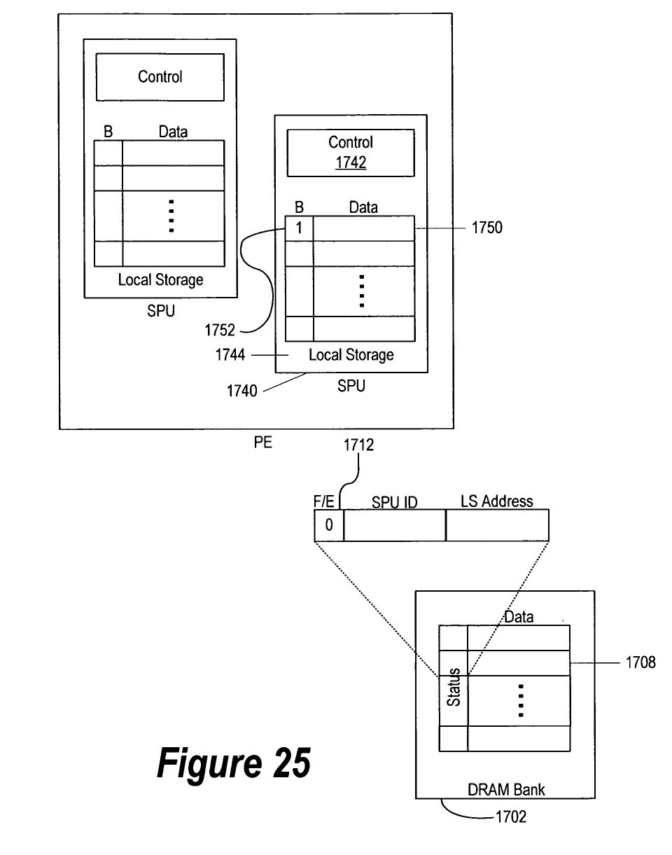

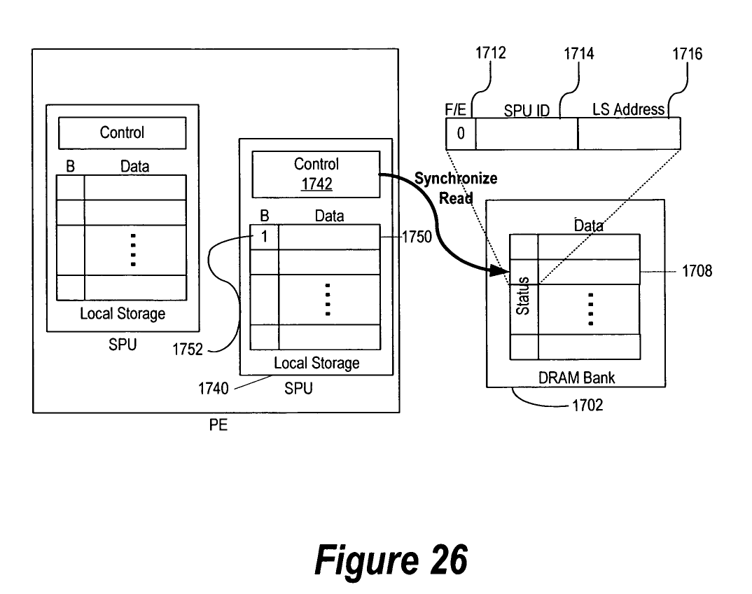

FIGS. 25-31 illustrate the synchronized reading of data from a memory location of DRAM 1702, e.g., memory location 1708, to an LS memory location of an SPU's local storage, e.g., LS memory location 1752 of local storage 1744, when the F/E bit for the memory location of DRAM 1702 is set to 0 to indicate that the data in this memory location are not current or valid. As shown in FIG. 25, to initiate this transfer, the busy bit in memory segment 1752 of LS memory location 1750 is set to 1 to reserve this LS memory location for this transfer of data. As shown in FIG. 26, control logic 1742 next issues a synchronize read command for memory location 1708 of DRAM 1702. Since the F/E bit associated with this memory location, F/E bit 1712, is set to 0, the data stored in memory location 1708 are invalid. As a result, a signal is transmitted to control logic 1742 to block the immediate reading of data from this memory location.

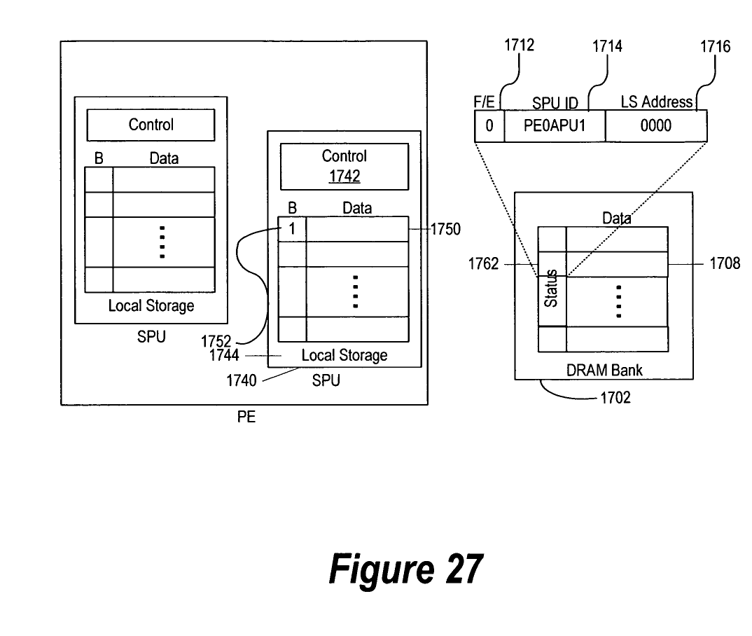

As shown in FIG. 27, the SPU ID 1714 and LS address 1716 for this read command next are written into memory segment 1762. In this case, the SPU ID for SPU 1740 and the LS memory location for LS memory location 1750 are written into memory segment 1762. When the data within memory location 1708 become current, therefore, this SPU ID and LS memory location are used for determining the location to which the current data are to be transmitted.

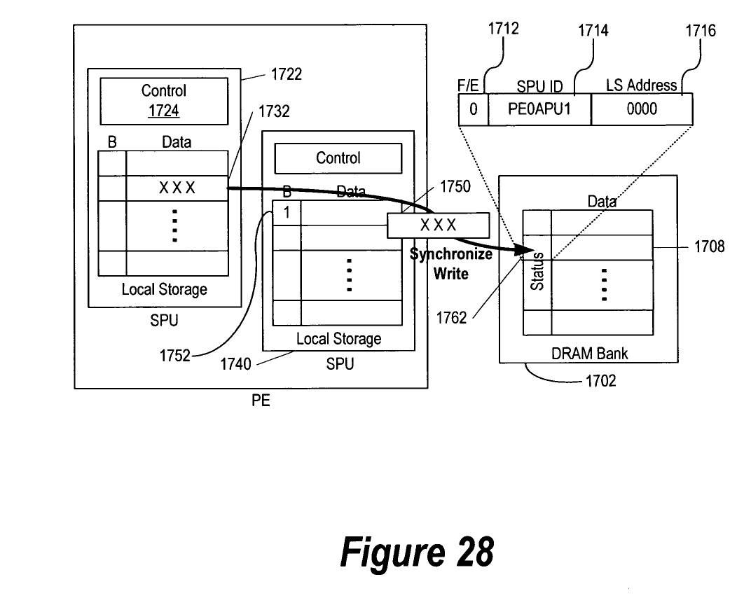

The data in memory location 1708 become valid and current when an SPU writes data into this memory location. The synchronized writing of data into memory location 1708 from, e.g., memory location 1732 of SPU 1722, is illustrated in FIG. 28. This synchronized writing of these data is permitted because F/E bit 1712 for this memory location is set to 0.

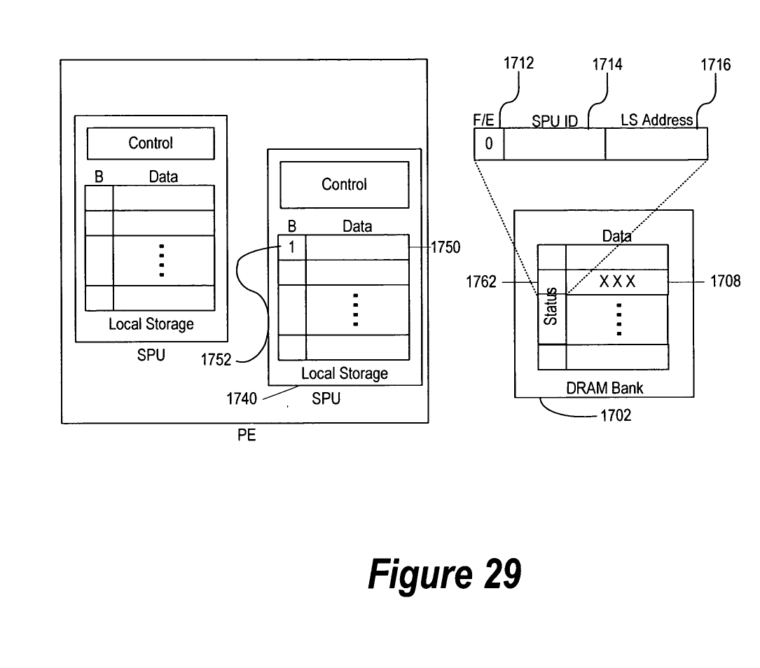

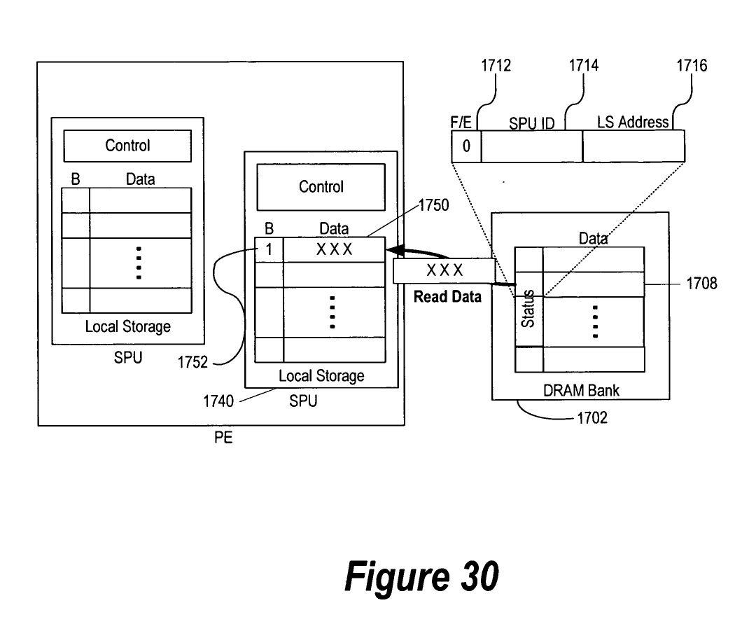

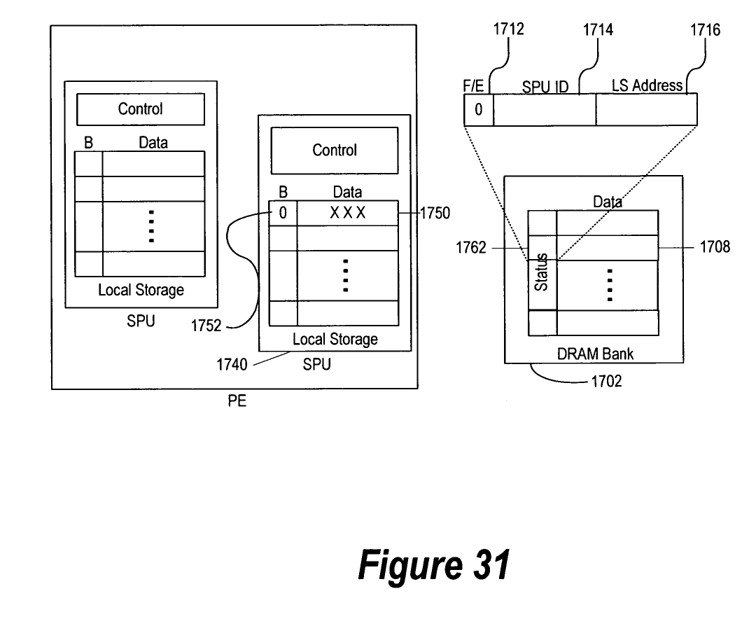

As shown in FIG. 29, following this writing, the data in memory location 1708 become current and valid. SPU ID 1714 and LS address 1716 from memory segment 1762, therefore, immediately are read from memory segment 1762, and this information then is deleted from this segment. F/E bit 1712 also is set to 0 in anticipation of the immediate reading of the data in memory location 1708. As shown in FIG. 30, upon reading SPU ID 1714 and LS address 1716, this information immediately is used for reading the valid data in memory location 1708 to LS memory location 1750 of SPU 1740. The final state is shown in FIG. 31. This figure shows the valid data from memory location 1708 copied to memory location 1750, the busy bit in memory segment 1752 set to 0 and F/E bit 1712 in memory segment 1762 set to 0. The setting of this busy bit to 0 enables LS memory location 1750 now to be accessed by SPU 1740 for any purpose. The setting of this F/E bit to 0 indicates that the data in memory location 1708 no longer are current and valid.

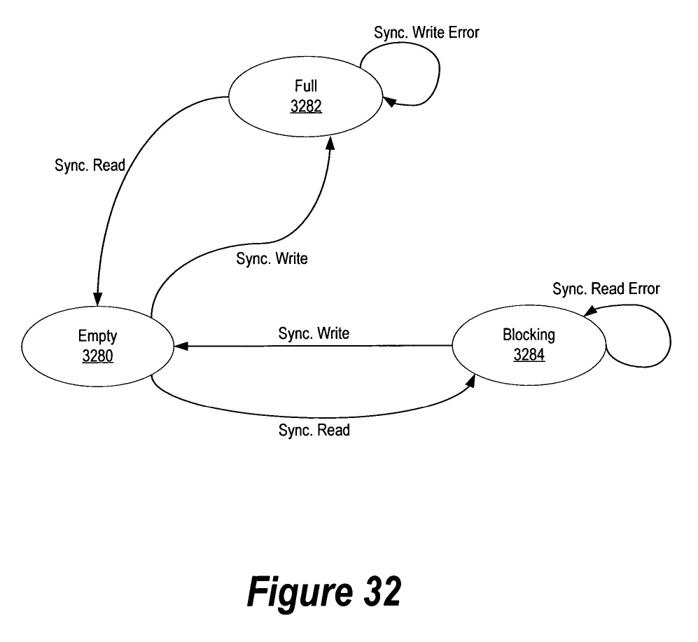

FIG. 32 summarizes the operations described above and the various states of a memory location of the DRAM based upon the states of the F/E bit, the SPU ID and the LS address stored in the memory segment corresponding to the memory location. The memory location can have three states. These three states are an empty state 3280 in which the F/E bit is set to 0 and no information is provided for the SPU ID or the LS address, a full state 3282 in which the F/E bit is set to 1 and no information is provided for the SPU ID or LS address and a blocking state 3284 in which the F/E bit is set to 0 and information is provided for the SPU ID and LS address.

As shown in this figure, in empty state 3280, a synchronized writing operation is permitted and results in a transition to full state 3282. A synchronized reading operation, however, results in a transition to the blocking state 3284 because the data in the memory location, when the memory location is in the empty state, are not current.

In full state 3282, a synchronized reading operation is permitted and results in a transition to empty state 3280. On the other hand, a synchronized writing operation in full state 3282 is prohibited to prevent overwriting of valid data. If such a writing operation is attempted in this state, no state change occurs and an error message is transmitted to the SPU's corresponding control logic.

In blocking state 3284, the synchronized writing of data into the memory location is permitted and results in a transition to empty state 3280. On the other hand, a synchronized reading operation in blocking state 3284 is prohibited to prevent a conflict with the earlier synchronized reading operation which resulted in this state. If a synchronized reading operation is attempted in blocking state 3284, no state change occurs and an error message is transmitted to the SPU's corresponding control logic.

The scheme described above for the synchronized reading and writing of data from and to the shared DRAM also can be used for eliminating the computational resources normally dedicated by a processor for reading data from, and writing data to, external devices. This input/output (I/O) function could be performed by a PU. However, using a modification of this synchronization scheme, an SPU running an appropriate program can perform this function. For example, using this scheme, a PU receiving an interrupt request for the transmission of data from an I/O interface initiated by an external device can delegate the handling of this request to this SPU. The SPU then issues a synchronize write command to the I/O interface. This interface in turn signals the external device that data now can be written into the DRAM. The SPU next issues a synchronize read command to the DRAM to set the DRAM's relevant memory space into a blocking state. The SPU also sets to 1 the busy bits for the memory locations of the SPU's local storage needed to receive the data. In the blocking state, the additional memory segments associated with the DRAM's relevant memory space contain the SPU's ID and the address of the relevant memory locations of the SPU's local storage. The external device next issues a synchronize write command to write the data directly to the DRAM's relevant memory space. Since this memory space is in the blocking state, the data are immediately read out of this space into the memory locations of the SPU's local storage identified in the additional memory segments. The busy bits for these memory locations then are set to 0. When the external device completes writing of the data, the SPU issues a signal to the PU that the transmission is complete.

Using this scheme, therefore, data transfers from external devices can be processed with minimal computational load on the PU. The SPU delegated this function, however, should be able to issue an interrupt request to the PU, and the external device should have direct access to the DRAM.

The DRAM of each PU includes a plurality of “sandboxes.” A sandbox defines an area of the shared DRAM beyond which a particular SPU, or set of SPUs, cannot read or write data. These sandboxes provide security against the corruption of data being processed by one SPU by data being processed by another SPU. These sandboxes also permit the downloading of software cells from network 104 into a particular sandbox without the possibility of the software cell corrupting data throughout the DRAM. In the present invention, the sandboxes are implemented in the hardware of the DRAMs and DMACs. By implementing these sandboxes in this hardware rather than in software, advantages in speed and security are obtained.

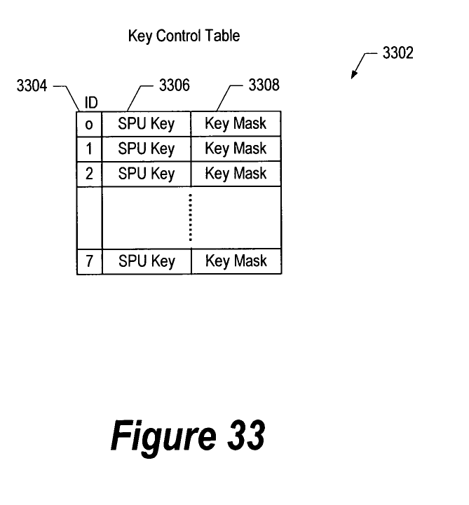

The PU of a PU controls the sandboxes assigned to the SPUs. Since the PU normally operates only trusted programs, such as an operating system, this scheme does not jeopardize security. In accordance with this scheme, the PU builds and maintains a key control table. This key control table is illustrated in FIG. 33. As shown in this figure, each entry in key control table 3302 contains an identification (ID) 3304 for an SPU, an SPU key 3306 for that SPU and a key mask 3308. The use of this key mask is explained below. Key control table 3302 preferably is stored in a relatively fast memory, such as a static random access memory (SRAM), and is associated with the DMAC. The entries in key control table 3302 are controlled by the PU. When an SPU requests the writing of data to, or the reading of data from, a particular storage location of the DRAM, the DMAC evaluates the SPU key 3306 assigned to that SPU in key control table 3302 against a memory access key associated with that storage location.

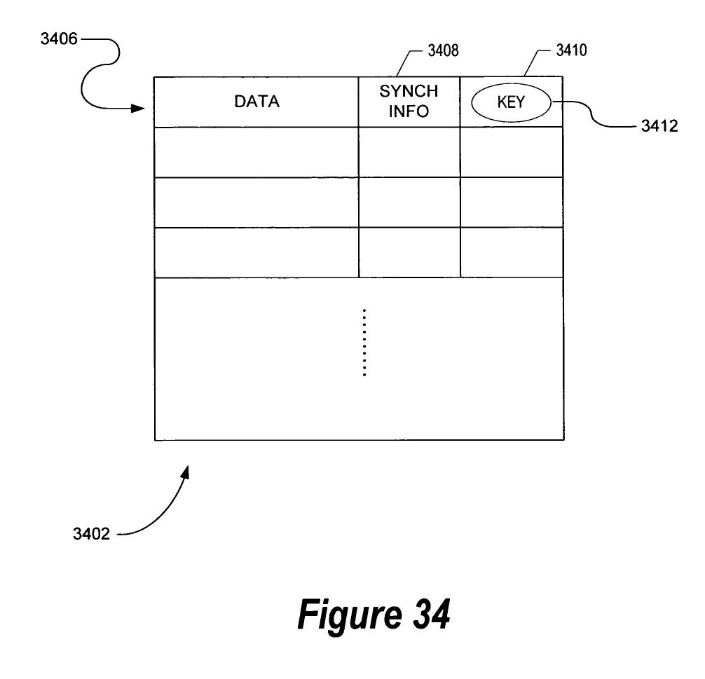

As shown in FIG. 34, a dedicated memory segment 3410 is assigned to each addressable storage location 3406 of a DRAM 3402. A memory access key 3412 for the storage location is stored in this dedicated memory segment. As discussed above, a further additional dedicated memory segment 3408, also associated with each addressable storage location 3406, stores synchronization information for writing data to, and reading data from, the storage-location.

In operation, an SPU issues a DMA command to the DMAC. This command includes the address of a storage location 3406 of DRAM 3402. Before executing this command, the DMAC looks up the requesting SPU's key 3306 in key control table 3302 using the SPU's ID 3304. The DMAC then compares the SPU key 3306 of the requesting SPU to the memory access key 3412 stored in the dedicated memory segment 3410 associated with the storage location of the DRAM to which the SPU seeks access. If the two keys do not match, the DMA command is not executed. On the other hand, if the two keys match, the DMA command proceeds and the requested memory access is executed.

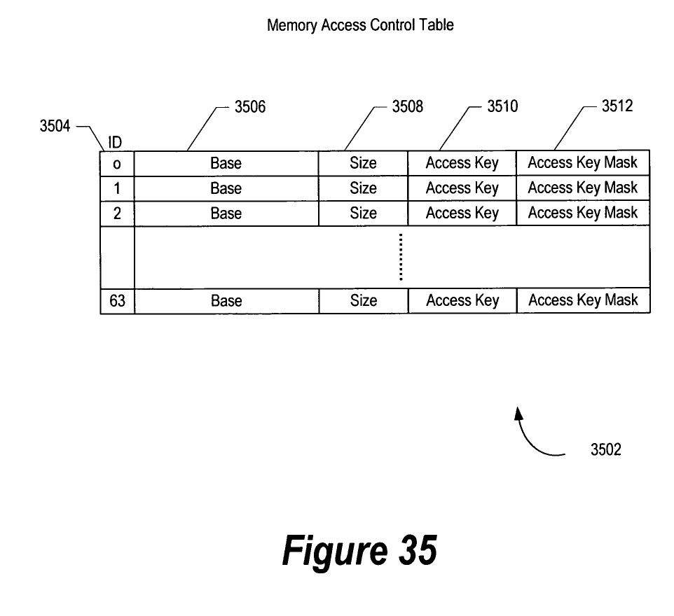

An alternative embodiment is illustrated in FIG. 35. In this embodiment, the PU also maintains a memory access control table 3502. Memory access control table 3502 contains an entry for each sandbox within the DRAM. In the particular example of FIG. 35, the DRAM contains 64 sandboxes. Each entry in memory access control table 3502 contains an identification (ID) 3504 for a sandbox, a base memory address 3506, a sandbox size 3508, a memory access key 3510 and an access key mask 3512. Base memory address 3506 provides the address in the DRAM which starts a particular memory sandbox. Sandbox size 3508 provides the size of the sandbox and, therefore, the endpoint of the particular sandbox.

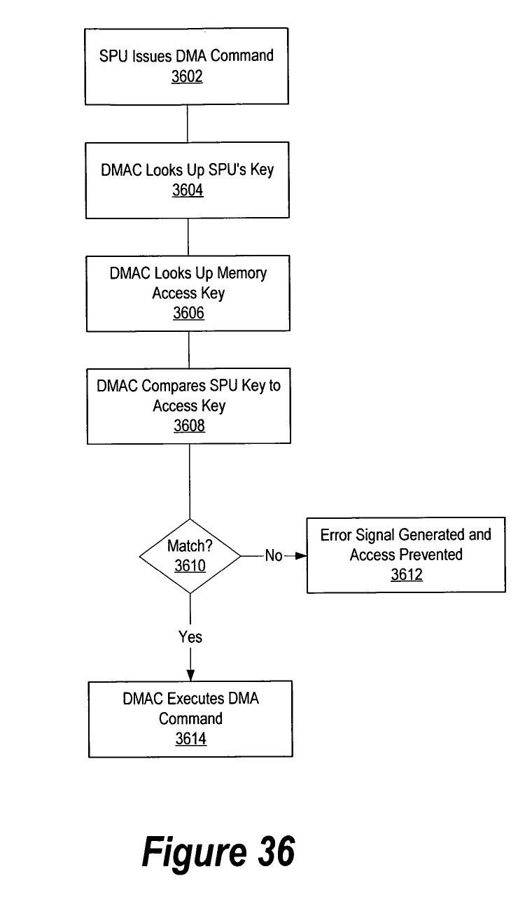

FIG. 36 is a flow diagram of the steps for executing a DMA command using key control table 3302 and memory access control table 3502. In step 3602, an SPU issues a DMA command to the DMAC for access to a particular memory location or locations within a sandbox. This command includes a sandbox ID 3504 identifying the particular sandbox for which access is requested. In step 3604, the DMAC looks up the requesting SPU's key 3306 in key control table 3302 using the SPU's ID 3304. In step 3606, the DMAC uses the sandbox ID 3504 in the command to look up in memory access control table 3502 the memory access key 3510 associated with that sandbox. In step 3608, the DMAC compares the SPU key 3306 assigned to the requesting SPU to the access key 3510 associated with the sandbox. In step 3610, a determination is made of whether the two keys match. If the two keys do not match, the process moves to step 3612 where the DMA command does not proceed and an error message is sent to either the requesting SPU, the PU or both. On the other hand, if at step 3610 the two keys are found to match, the process proceeds to step 3614 where the DMAC executes the DMA command.

The key masks for the SPU keys and the memory access keys provide greater flexibility to this system. A key mask for a key converts a masked bit into a wildcard. For example, if the key mask 3308 associated with an SPU key 3306 has its last two bits set to “mask,” designated by, e.g., setting these bits in key mask 3308 to 1, the SPU key can be either a 1 or a 0 and still match the memory access key. For example, the SPU key might be 1010. This SPU key normally allows access only to a sandbox having an access key of 1010. If the SPU key mask for this SPU key is set to 0001, however, then this SPU key can be used to gain access to sandboxes having an access key of either 1010 or 1011. Similarly, an access key 1010 with a mask set to 0001 can be accessed by an SPU with an SPU key of either 1010 or 1011. Since both the SPU key mask and the memory key mask can be used simultaneously, numerous variations of accessibility by the SPUs to the sandboxes can be established.

The present invention also provides a new programming model for the processors of system 101. This programming model employs software cells 102. These cells can be transmitted to any processor on network 104 for processing. This new programming model also utilizes the unique modular architecture of system 101 and the processors of system 101.

Software cells are processed directly by the SPUs from the SPU's local storage. The SPUs do not directly operate on any data or programs in the DRAM. Data and programs in the DRAM are read into the SPU's local storage before the SPU processes these data and programs. The SPU's local storage, therefore, includes a program counter, stack and other software elements for executing these programs. The PU controls the SPUs by issuing direct memory access (DMA) commands to the DMAC.

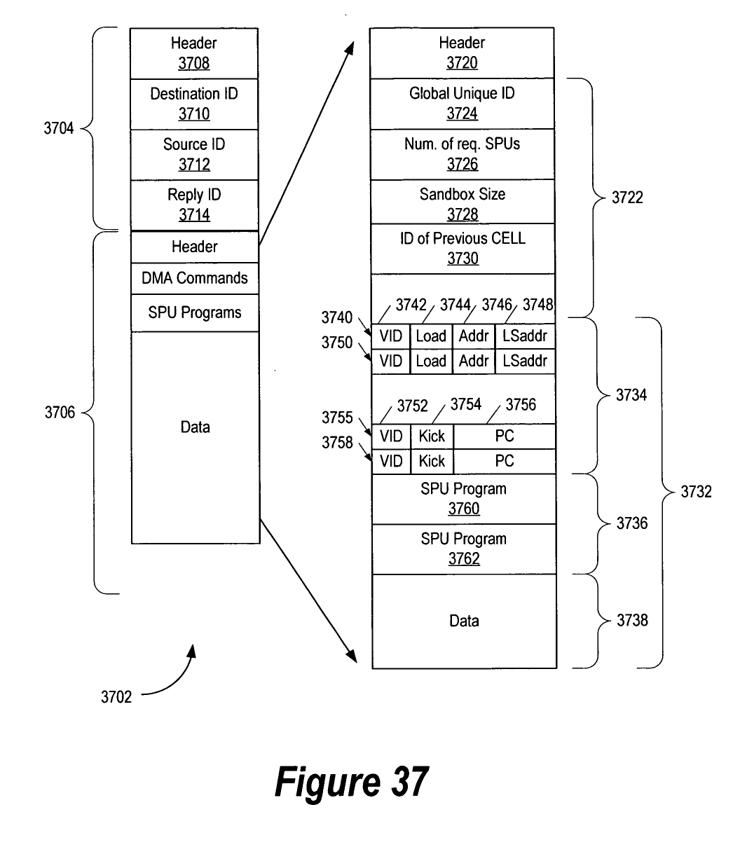

The structure of software cells 102 is illustrated in FIG. 37. As shown in this figure, a software cell, e.g., software cell 3702, contains routing information section 3704 and body 3706. The information contained in routing information section 3704 is dependent upon the protocol of network 104. Routing information section 3704 contains header 3708, destination ID 3710, source ID 3712 and reply ID 3714. The destination ID includes a network address. Under the TCP/IP protocol, e.g., the network address is an Internet protocol (IP) address. Destination ID 3710 further includes the identity of the PU and SPU to which the cell should be transmitted for processing. Source ID 3712 contains a network address and identifies the PU and SPU from which the cell originated to enable the destination PU and SPU to obtain additional information regarding the cell if necessary. Reply ID 3714 contains a network address and identifies the PU and SPU to which queries regarding the cell, and the result of processing of the cell, should be directed.

Cell body 3706 contains information independent of the network's protocol. The exploded portion of FIG. 37 shows the details of cell body 3706. Header 3720 of cell body 3706 identifies the start of the cell body. Cell interface 3722 contains information necessary for the cell's utilization. This information includes global unique ID 3724, required SPUs 3726, sandbox size 3728 and previous cell ID 3730.

Global unique ID 3724 uniquely identifies software cell 3702 throughout network 104. Global unique ID 3724 is generated on the basis of source ID 3712, e.g. the unique identification of a PU or SPU within source ID 3712, and the time and date of generation or transmission of software cell 3702. Required SPUs 3726 provides the minimum number of SPUs required to execute the cell. Sandbox size 3728 provides the amount of protected memory in the required SPUs' associated DRAM necessary to execute the cell. Previous cell ID 3730 provides the identity of a previous cell in a group of cells requiring sequential execution, e.g., streaming data.

Implementation section 3732 contains the cell's core information. This information includes DMA command list 3734, programs 3736 and data 3738. Programs 3736 contain the programs to be run by the SPUs (called “spulets”), e.g., SPU programs 3760 and 3762, and data 3738 contain the data to be processed with these programs. DMA command list 3734 contains a series of DMA commands needed to start the programs. These DMA commands include DMA commands 3740, 3750, 3755 and 3758. The PU issues these DMA commands to the DMAC.

DMA command 3740 includes VID 3742. VID 3742 is the virtual ID of an SPU which is mapped to a physical ID when the DMA commands are issued. DMA command 3740 also includes load command 3744 and address 3746. Load command 3744 directs the SPU to read particular information from the DRAM into local storage. Address 3746 provides the virtual address in the DRAM containing this information. The information can be, e.g., programs from programs section 3736, data from data section 3738 or other data. Finally, DMA command 3740 includes local storage address 3748. This address identifies the address in local storage where the information should be loaded. DMA commands 3750 contain similar information. Other DMA commands are also possible.

DMA command list 3734 also includes a series of kick commands, e.g., kick commands 3755 and 3758. Kick commands are commands issued by a PU to an SPU to initiate the processing of a cell. DMA kick command 3755 includes virtual SPU ID 3752, kick command 3754 and program counter 3756. Virtual SPU ID 3752 identifies the SPU to be kicked, kick command 3754 provides the relevant kick command and program counter 3756 provides the address for the program counter for executing the program. DMA kick command 3758 provides similar information for the same SPU or another SPU.

As noted, the PUs treat the SPUs as independent processors, not co-processors. To control processing by the SPUs, therefore, the PU uses commands analogous to remote procedure calls. These commands are designated “SPU Remote Procedure Calls” (SRPCs). A PU implements an SRPC by issuing a series of DMA commands to the DMAC. The DMAC loads the SPU program and its associated stack frame into the local storage of an SPU. The PU then issues an initial kick to the SPU to execute the SPU Program.

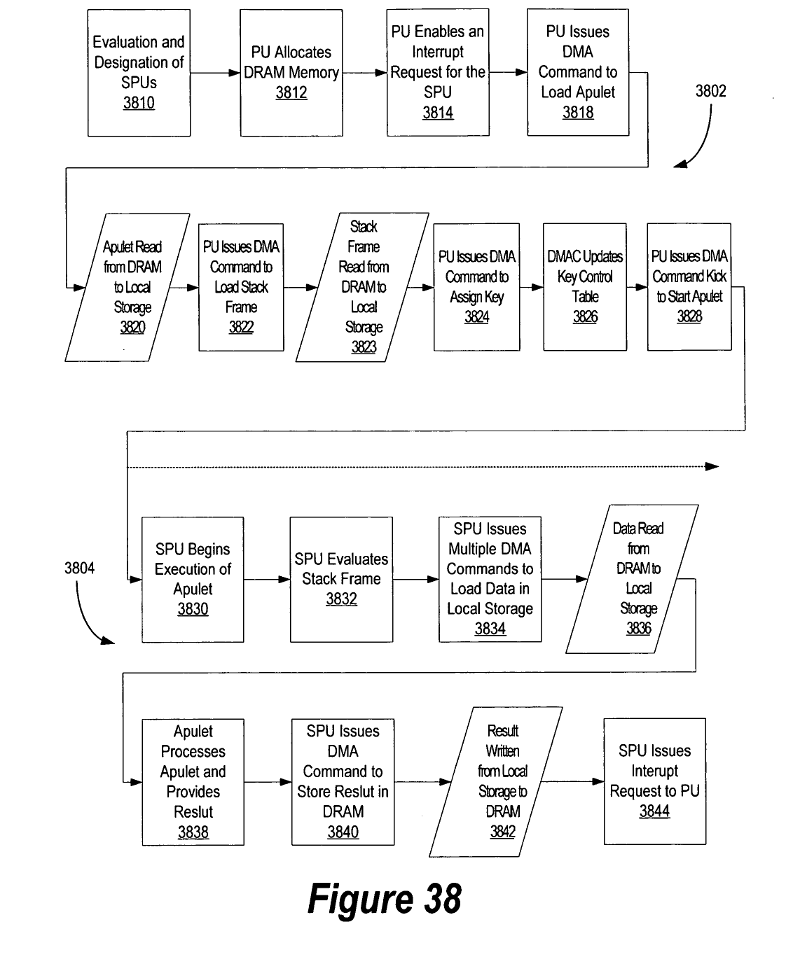

FIG. 38 illustrates the steps of an SRPC for executing an spulet. The steps performed by the PU in initiating processing of the spulet by a designated SPU are shown in the first portion 3802 of FIG. 38, and the steps performed by the designated SPU in processing the spulet are shown in the second portion 3804 of FIG. 38.

In step 3810, the PU evaluates the spulet and then designates an SPU for processing the spulet. In step 3812, the PU allocates space in the DRAM for executing the spulet by issuing a DMA command to the DMAC to set memory access keys for the necessary sandbox or sandboxes. In step 3814, the PU enables an interrupt request for the designated SPU to signal completion of the spulet. In step 3818, the PU issues a DMA command to the DMAC to load the spulet from the DRAM to the local storage of the SPU. In step 3820, the DMA command is executed, and the spulet is read from the DRAM to the SPU's local storage. In step 3822, the PU issues a DMA command to the DMAC to load the stack frame associated with the spulet from the DRAM to the SPU's local storage. In step 3823, the DMA command is executed, and the stack frame is read from the DRAM to the SPU's local storage. In step 3824, the PU issues a DMA command for the DMAC to assign a key to the SPU to allow the SPU to read and write data from and to the hardware sandbox or sandboxes designated in step 3812. In step 3826, the DMAC updates the key control table (KTAB) with the key assigned to the SPU. In step 3828, the PU issues a DMA command “kick” to the SPU to start processing of the program. Other DMA commands may be issued by the PU in the execution of a particular SRPC depending upon the particular spulet.

As indicated above, second portion 3804 of FIG. 38 illustrates the steps performed by the SPU in executing the spulet. In step 3830, the SPU begins to execute the spulet in response to the kick command issued at step 3828. In step 3832, the SPU, at the direction of the spulet, evaluates the spulet's associated stack frame. In step 3834, the SPU issues multiple DMA commands to the DMAC to load data designated as needed by the stack frame from the DRAM to the SPU's local storage. In step 3836, these DMA commands are executed, and the data are read from the DRAM to the SPU's local storage. In step 3838, the SPU executes the spulet and generates a result. In step 3840, the SPU issues a DMA command to the DMAC to store the result in the DRAM. In step 3842, the DMA command is executed and the result of the spulet is written from the SPU's local storage to the DRAM. In step 3844, the SPU issues an interrupt request to the PU to signal that the SRPC has been completed.

The ability of SPUs to perform tasks independently under the direction of a PU enables a PU to dedicate a group of SPUs, and the memory resources associated with a group of SPUs, to performing extended tasks. For example, a PU can dedicate one or more SPUs, and a group of memory sandboxes associated with these one or more SPUs, to receiving data transmitted over network 104 over an extended period and to directing the data received during this period to one or more other SPUs and their associated memory sandboxes for further processing. This ability is particularly advantageous to processing streaming data transmitted over network 104, e.g., streaming MPEG or streaming ATRAC audio or video data. A PU can dedicate one or more SPUs and their associated memory sandboxes to receiving these data and one or more other SPUs and their associated memory sandboxes to decompressing and further processing these data. In other words, the PU can establish a dedicated pipeline relationship among a group of SPUs and their associated memory sandboxes for processing such data.

In order for such processing to be performed efficiently, however, the pipeline's dedicated SPUs and memory sandboxes should remain dedicated to the pipeline during periods in which processing of spulets comprising the data stream does not occur. In other words, the dedicated SPUs and their associated sandboxes should be placed in a reserved state during these periods. The reservation of an SPU and its associated memory sandbox or sandboxes upon completion of processing of an spulet is called a “resident termination.” A resident termination occurs in response to an instruction from a PU.

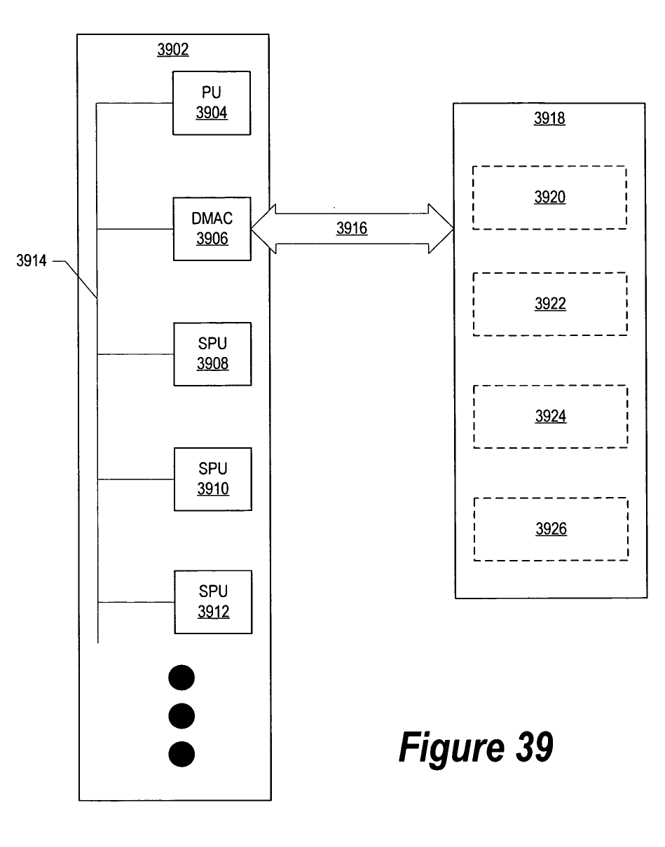

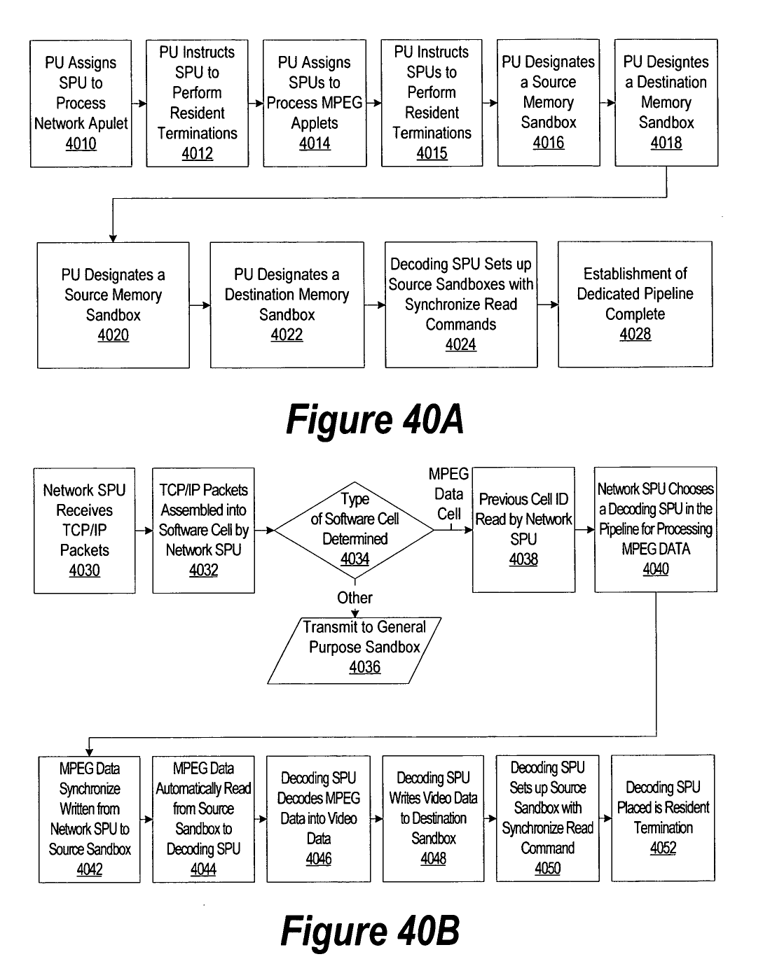

FIGS. 39, 40A and 40B illustrate the establishment of a dedicated pipeline structure comprising a group of SPUs and their associated sandboxes for the processing of streaming data, e.g., streaming MPEG data. As shown in FIG. 39, the components of this pipeline structure include PE 3902 and DRAM 3918. PE 3902 includes PU 3904, DMAC 3906 and a plurality of SPUs, including SPU 3908, SPU 3910 and SPU 3912. Communications among PU 3904, DMAC 3906 and these SPUs occur through PE bus 3914. Wide bandwidth bus 3916 connects DMAC 3906 to DRAM 3918. DRAM 3918 includes a plurality of sandboxes, e.g., sandbox 3920, sandbox 3922, sandbox 3924 and sandbox 3926.

FIG. 40A illustrates the steps for establishing the dedicated pipeline. In step 4010, PU 3904 assigns SPU 3908 to process a network spulet. A network spulet comprises a program for processing the network protocol of network 104. In this case, this protocol is the Transmission Control Protocol/Internet Protocol (TCP/IP). TCP/IP data packets conforming to this protocol are transmitted over network 104. Upon receipt, SPU 3908 processes these packets and assembles the data in the packets into software cells 102. In step 4012, PU 3904 instructs SPU 3908 to perform resident terminations upon the completion of the processing of the network spulet. In step 4014, PU 3904 assigns PUs 3910 and 3912 to process MPEG spulets. In step 4015, PU 3904 instructs SPUs 3910 and 3912 also to perform resident terminations upon the completion of the processing of the MPEG spulets. In step 4016, PU 3904 designates sandbox 3920 as a source sandbox for access by SPU 3908 and SPU 3910. In step 4018, PU 3904 designates sandbox 3922 as a destination sandbox for access by SPU 3910. In step 4020, PU 3904 designates sandbox 3924 as a source sandbox for access by SPU 3908 and SPU 3912. In step 4022, PU 3904 designates sandbox 3926 as a destination sandbox for access by SPU 3912. In step 4024, SPU 3910 and SPU 3912 send synchronize read commands to blocks of memory within, respectively, source sandbox 3920 and source sandbox 3924 to set these blocks of memory into the blocking state. The process finally moves to step 4028 where establishment of the dedicated pipeline is complete and the resources dedicated to the pipeline are reserved. SPUs 3908, 3910 and 3912 and their associated sandboxes 3920, 3922, 3924 and 3926, therefore, enter the reserved state.

FIG. 40B illustrates the steps for processing streaming MPEG data by this dedicated pipeline. In step 4030, SPU 3908, which processes the network spulet, receives in its local storage TCP/IP data packets from network 104. In step 4032, SPU 3908 processes these TCP/IP data packets and assembles the data within these packets into software cells 102. In step 4034, SPU 3908 examines header 3720 (FIG. 37) of the software cells to determine whether the cells contain MPEG data. If a cell does not contain MPEG data, then, in step 4036, SPU 3908 transmits the cell to a general purpose sandbox designated within DRAM 3918 for processing other data by other SPUs not included within the dedicated pipeline. SPU 3908 also notifies PU 3904 of this transmission.

On the other hand, if a software cell contains MPEG data, then, in step 4038, SPU 3908 examines previous cell ID 3730 (FIG. 37) of the cell to identify the MPEG data stream to which the cell belongs. In step 4040, SPU 3908 chooses an SPU of the dedicated pipeline for processing of the cell. In this case, SPU 3908 chooses SPU 3910 to process these data. This choice is based upon previous cell ID 3730 and load balancing factors. For example, if previous cell ID 3730 indicates that the previous software cell of the MPEG data stream to which the software cell belongs was sent to SPU 3910 for processing, then the present software cell normally also will be sent to SPU 3910 for processing. In step 4042, SPU 3908 issues a synchronize write command to write the MPEG data to sandbox 3920. Since this sandbox previously was set to the blocking state, the MPEG data, in step 4044, automatically is read from sandbox 3920 to the local storage of SPU 3910. In step 4046, SPU 3910 processes the MPEG data in its local storage to generate video data. In step 4048, SPU 3910 writes the video data to sandbox 3922. In step 4050, SPU 3910 issues a synchronize read command to sandbox 3920 to prepare this sandbox to receive additional MPEG data. In step 4052, SPU 3910 processes a resident termination. This processing causes this SPU to enter the reserved state during which the SPU waits to process additional MPEG data in the MPEG data stream.

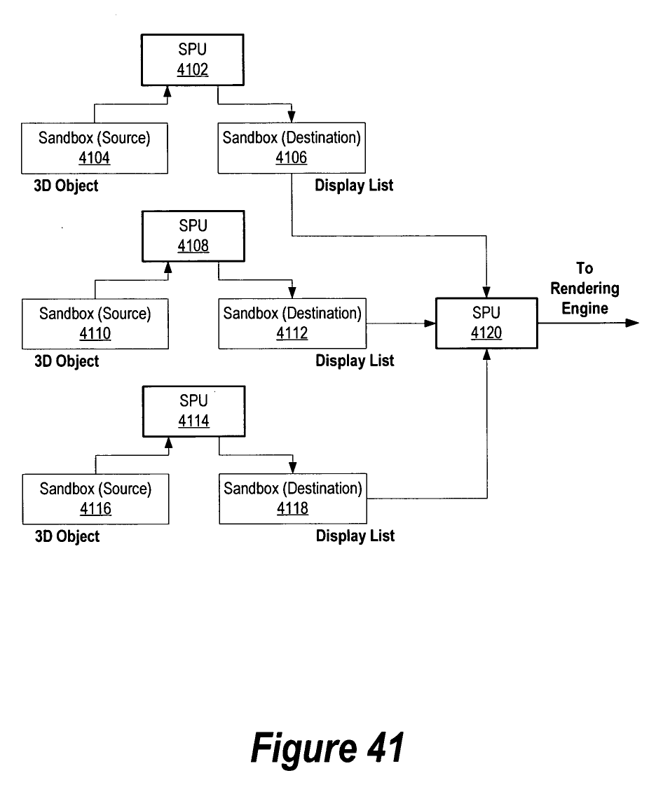

Other dedicated structures can be established among a group of SPUs and their associated sandboxes for processing other types of data. For example, as shown in FIG. 41, a dedicated group of SPUs, e.g., SPUs 4102, 4108 and 4114, can be established for performing geometric transformations upon three dimensional objects to generate two dimensional display lists. These two dimensional display lists can be further processed (rendered) by other SPUs to generate pixel data. To perform this processing, sandboxes are dedicated to SPUs 4102, 4108 and 4114 for storing the three dimensional objects and the display lists resulting from the processing of these objects. For example, source sandboxes 4104, 4110 and 4116 are dedicated to storing the three dimensional objects processed by, respectively, SPU 4102, SPU 4108 and SPU 4114. In a similar manner, destination sandboxes 4106, 4112 and 4118 are dedicated to storing the display lists resulting from the processing of these three dimensional objects by, respectively, SPU 4102, SPU 4108 and SPU 4114.

Coordinating SPU 4120 is dedicated to receiving in its local storage the display lists from destination sandboxes 4106, 4112 and 4118. SPU 4120 arbitrates among these display lists and sends them to other SPUs for the rendering of pixel data.

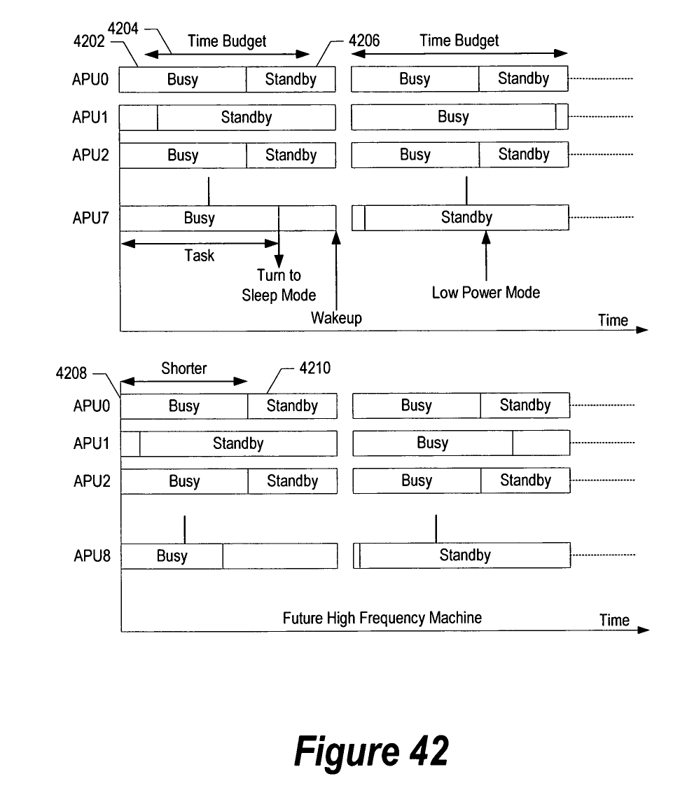

The processors of system 101 also employ an absolute timer. The absolute timer provides a clock signal to the SPUs and other elements of a PU which is both independent of, and faster than, the clock signal driving these elements. The use of this absolute timer is illustrated in FIG. 42.

As shown in this figure, the absolute timer establishes a time budget for the performance of tasks by the SPUs. This time budget provides a time for completing these tasks which is longer than that necessary for the SPUs' processing of the tasks. As a result, for each task, there is, within the time budget, a busy period and a standby period. All spulets are written for processing on the basis of this time budget regardless of the SPUs' actual processing time or speed.

For example, for a particular SPU of a PU, a particular task may be performed during busy period 4202 of time budget 4204. Since busy period 4202 is less than time budget 4204, a standby period 4206 occurs during the time budget. During this standby period, the SPU goes into a sleep mode during which less power is consumed by the SPU.

The results of processing a task are not expected by other SPUs, or other elements of a PU, until a time budget 4204 expires. Using the time budget established by the absolute timer, therefore, the results of the SPUs' processing always are coordinated regardless of the SPUs' actual processing speeds.

In the future, the speed of processing by the SPUs will become faster. The time budget established by the absolute timer, however, will remain the same. For example, as shown in FIG. 42, an SPU in the future will execute a task in a shorter period and, therefore, will have a longer standby period. Busy period 4208, therefore, is shorter than busy period 4202, and standby period 4210 is longer than standby period 4206. However, since programs are written for processing on the basis of the same time budget established by the absolute timer, coordination of the results of processing among the SPUs is maintained. As a result, faster SPUs can process programs written for slower SPUs without causing conflicts in the times at which the results of this processing are expected.

In lieu of an absolute timer to establish coordination among the SPUs, the PU, or one or more designated SPUs, can analyze the particular instructions or microcode being executed by an SPU in processing an spulet for problems in the coordination of the SPUs' parallel processing created by enhanced or different operating speeds. “No operation” (“NOOP”) instructions can be inserted into the instructions and executed by some of the SPUs to maintain the proper sequential completion of processing by the SPUs expected by the spulet. By inserting these NOOPs into the instructions, the correct timing for the SPUs' execution of all instructions can be maintained.

The Synergistic Processor Element (SPE) is the first implementation of a new processor architecture designed to accelerate media and streaming workloads. Area and power efficiency are important enablers for multi-core designs that take advantage of parallelism in applications. The architecture reduces area and power by solving “hard” scheduling problems such as data fetch and branch prediction in software. SPE provides an isolated execution mode that restricts access to certain resources to validated programs.

The focus on efficiency comes at the cost of multi-user operating system support. SPE load and store instructions are performed within a local address space, not in system address space. The local address space is untranslated, unguarded and non-coherent with respect to the system address space and is serviced by the Local Store (LS). Loads, stores and instruction fetch complete without exception, greatly simplifying the core design. The LS is a fully pipelined, single-ported, 256 KB SRAM that supports quadword (16 Byte) or line (128 Byte) access.

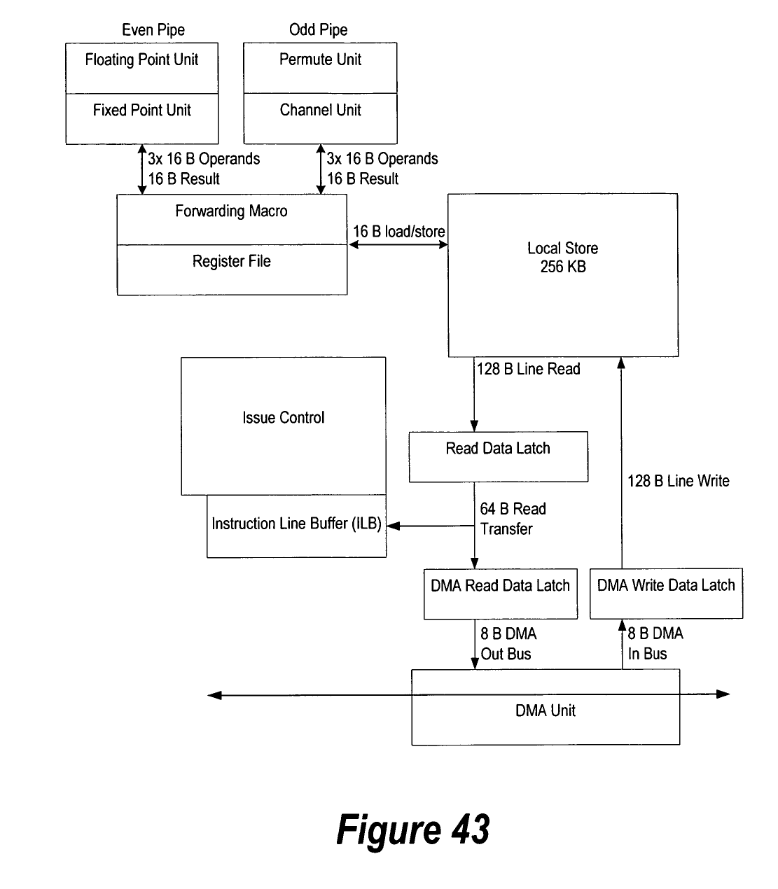

The SPE is a SIMD processor programmable in high level languages such as C or C++ with intrinsics. Most instructions process 128-bit operands, divided into four 32-bit words. The 128-bit operands are stored in a 128 entry unified register file used for integer, floating point and conditional operations. The large register file facilitates deep unrolling to fill execution pipelines. FIG. 43 shows how the SPE is organized and the key bandwidths (per cycle) between units.

Instructions are fetched from the LS in 32 4-byte groups when LS is idle. Fetch groups are aligned to 64 Byte boundaries, to improve the effective instruction fetch bandwidth. 3.5 fetched lines are stored in the instruction line buffer (ILB). A half line holds instructions while they are sequenced into the issue logic while another line holds the single entry software managed branch target buffer (SMBTB) and two lines are used for inline prefetching. Efficient software manages branches in three ways: it replaces branches with bit-wise select instructions; it arranges for the common case to be inline; or it inserts branch hint instructions to identify branches and load the probable targets into the SMBTB.

The SPE can issue up to 2 instructions per cycle to seven execution units organized into two execution pipelines. Instructions are issued in program order. Instruction fetch sends double word address aligned instruction pairs to the issue logic. Instruction pairs can be issued if the first instruction (from an even address) will be routed to an even pipe unit and the second instruction to an odd pipe unit. Loads and stores wait in the issue stage for an available LS cycle. Issue control and distribution require three cycles.

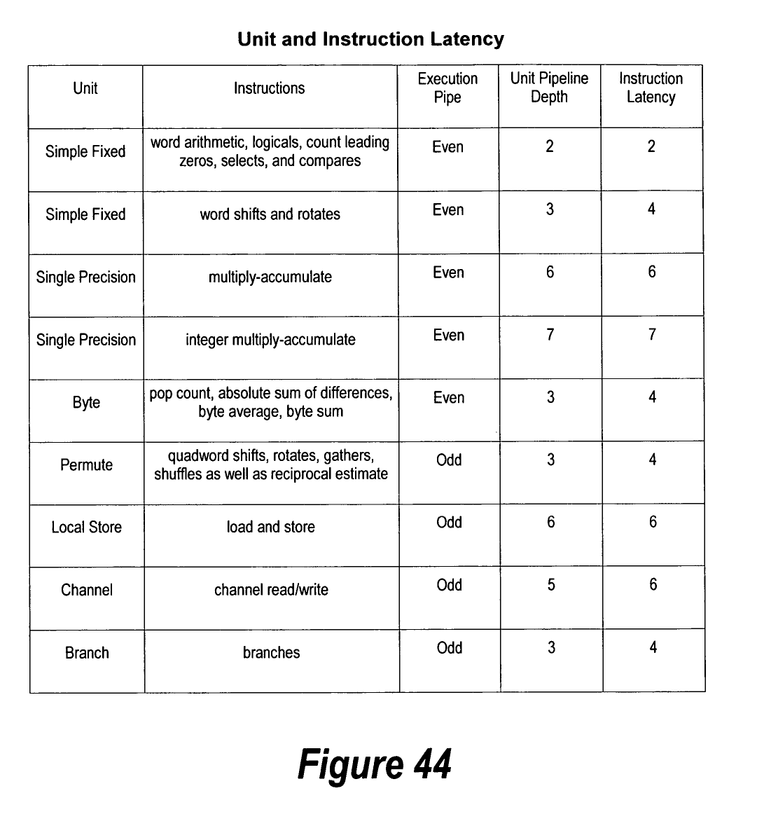

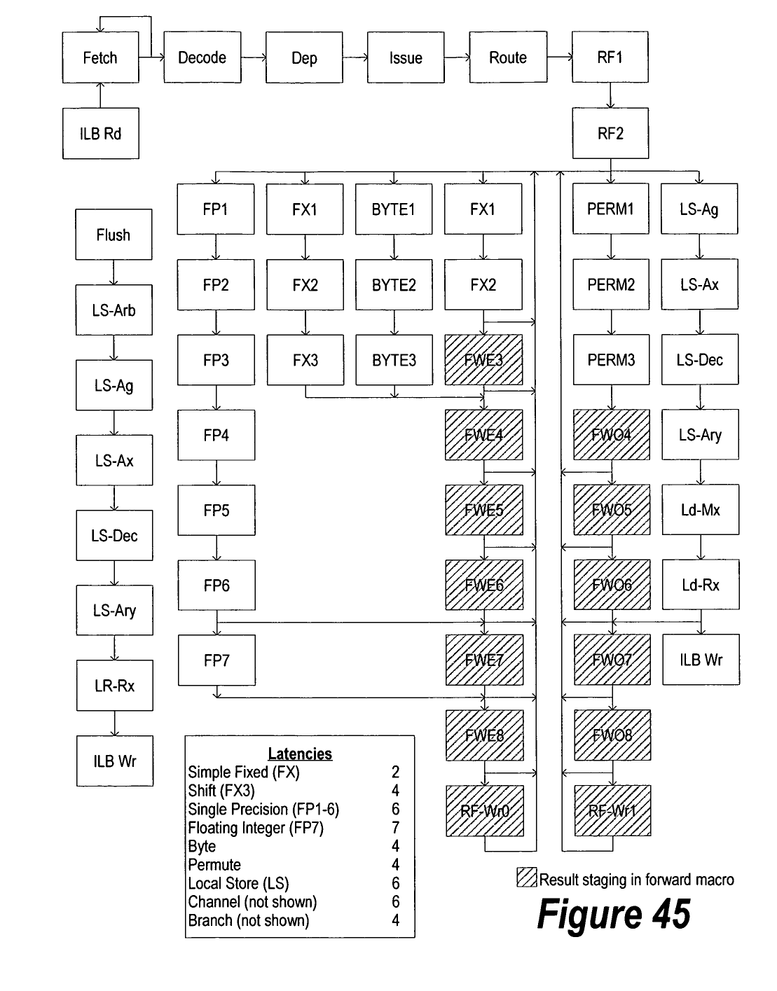

FIG. 44 details the eight execution units. Unit to pipeline assignment maximizes performance given the rigid issue rules. Simple fixed point, floating point and load results are bypassed directly from the unit output to input operands to reduce result latency. Other results are sent to the forward macro from where they are distributed a cycle later. FIG. 45 is a Pipeline diagram for the SPE that shows how flush and fetch are related to other instruction processing. Although frequency is an important element of SPE performance pipeline depth is similar to those found in 20 FO4 processors. Circuit design, efficient layout and logic simplification are the keys to supporting the 11 FO4 design frequency while constraining pipeline depth.

Operands are fetched either from the register file or forward network. The register file has six read ports, two write ports, 128 entries of 128 bits each and is accessed in two cycles. Register file data is sent directly to the functional unit operand latches. Results produced by functional units are held in the forward macro until they are committed and available from the register file. These results are read from 6 forward macro read-ports and distributed to the units in one cycle.

Data is transferred to and from the LS in 1024 bit lines by the SPE DMA engine. The SPE DMA engine allows software to schedule data transfers in parallel with core execution, and thereby overcome memory latency to achieve high memory bandwidth and improve performance. The SPE has separate 8 byte wide inbound and outbound data busses. The DMA engine supports transfers requested locally by the SPE through the SPE request queue and requested externally either via the external request queue or external bus requests through a window in the system address space. The SPE request queue supports up to 16 outstanding transfer requests. Each request can transfer up to 16 KB of data to or from the local address space. DMA request addresses are translated by the MMU before the request is sent to the bus. Software can check or be notified when requests or groups of requests are completed.

The SPE programs the DMA engine through the Channel Interface. The channel interface is a message passing interface intended to overlap I/O with data processing and minimize power consumed by synchronization. Channel facilities are accessed with three instructions: read channel, write channel, and read channel count which measures channel capacity. The SPE architecture supports up to 128 unidirectional channels which can be configured as blocking or non-blocking.

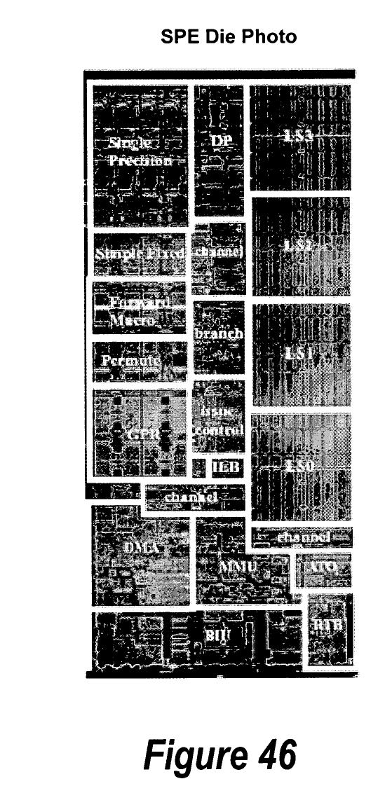

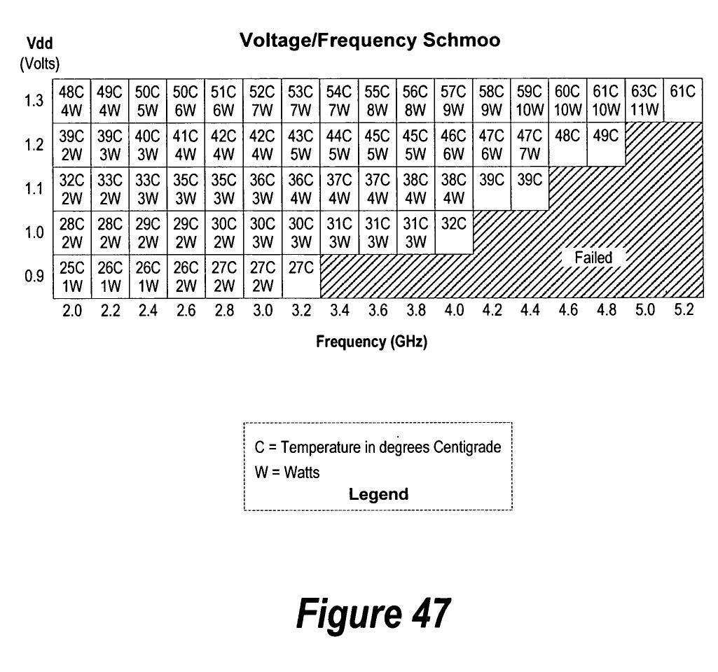

FIG. 46 is a photo of the 2.54×5.81 mm2 SPE. FIG. 47 is a voltage versus frequency shmoo that shows SPE active power and die temperature while running a single precision intensive lighting and transformation workload that averages 1.4 IPC. This is a computationally intensive application that has been unrolled 4 times and software pipelined to schedule out most instruction dependencies. It utilizes about 16 KB of LS. The relatively short instruction latency is important. If the execution pipelines were deeper, this algorithm would require further unrolling to hide the extra latency. More unrolling would require more than 128 registers and thus be impractical. Limiting pipeline depth also helps minimize power. The shmoo shows SPE dissipates 1 W at 2 GHz, 2 W at 3 GHz and 4 W of active power at 4 GHz. Although the shmoo shows function up to 5.2 GHz, separate experiments show that at 1.4 V and 56 o C, the SPE can achieve up to 5.6 GHz.

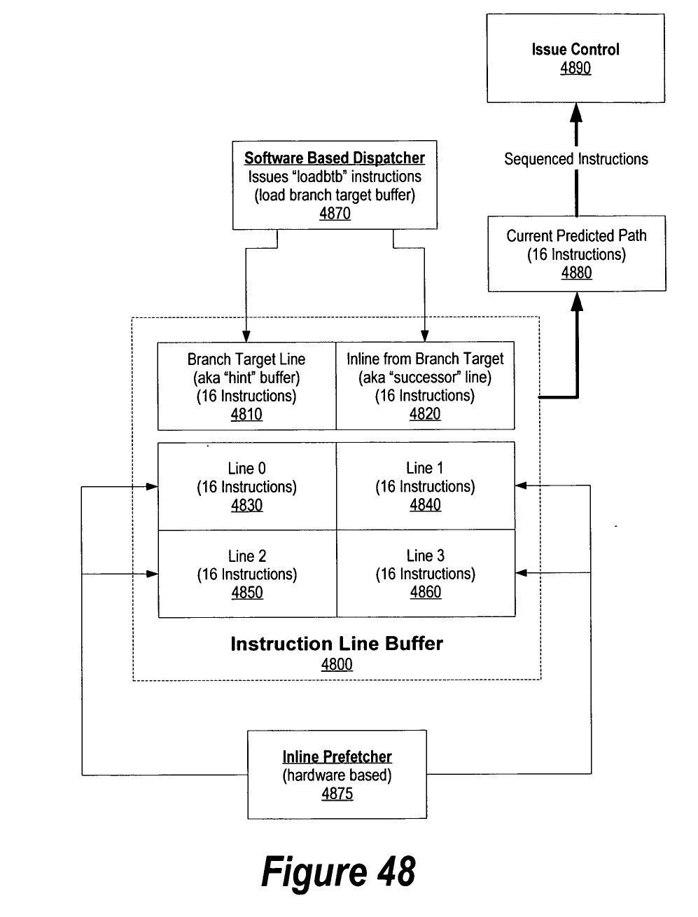

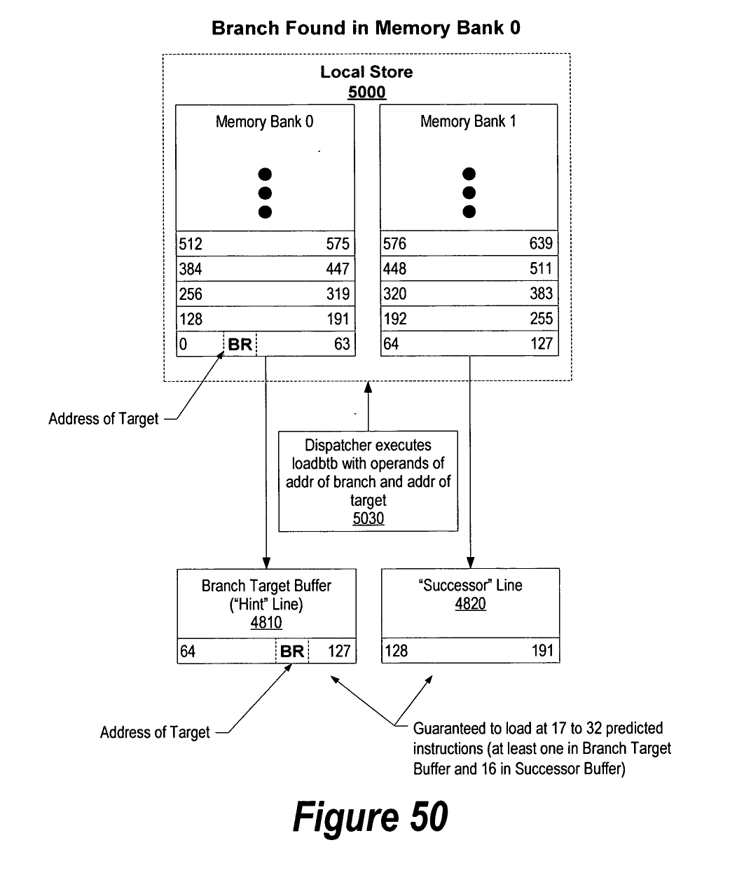

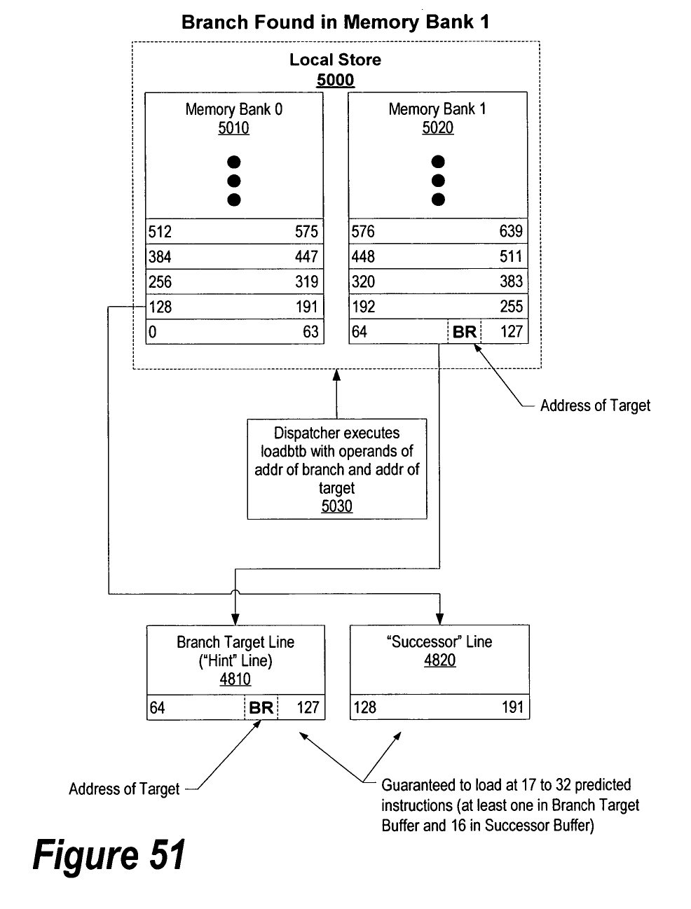

FIG. 48 is a diagram of the SPE Instruction Line Buffer (ILB). Instruction Line Buffer 4800 (also called “ILB” 4800) includes multiple instruction lines. In one embodiment, ILB includes Branch Target Line 4810 (also called “Hint Line” 4810, Inline from Branch Line 4820 (also called “Successor” line 4820), Lines 0 through 3 (4830, 4840, 4850, and 4860, respectively), as well as Current Predicted Path 4880 (also called “CPP” 4880). Data is loaded into Branch Target Line 4810 and 4820 as a result of a predicted branch instruction being encountered. In one embodiment, software-based dispatcher 4870 issues a special instruction, called a “load branch target buffer” (“loadbtb” instruction). The loadbtb instruction results in two instruction lines, each with 16 instructions, to be loaded into “hint” line 4810 and “successor” line 4820. In one embodiment, each line is 64 bytes long and includes 16 4-byte instructions. Also, the SPE embodiment discussed in FIGS. 43-47, ILB 4800 actually includes 3½ full lines with each line being 128 bytes in length and storing 32 4-byte instructions. In the ILB organization shown in FIGS. 48-56, a half-line is referred to as “a line” for simplicity. In other words, the branch target buffer portion of ILB 4800 is actually consists of branch target line 4810 and successor line 4820, with lines 4810 and 4820 actually being half-lines of a 32 byte instruction line. The reasons for breaking full lines into half lines will be apparent in the discussion of loading memory from two 16-byte memory banks as shown in FIGS. 50 and 51.

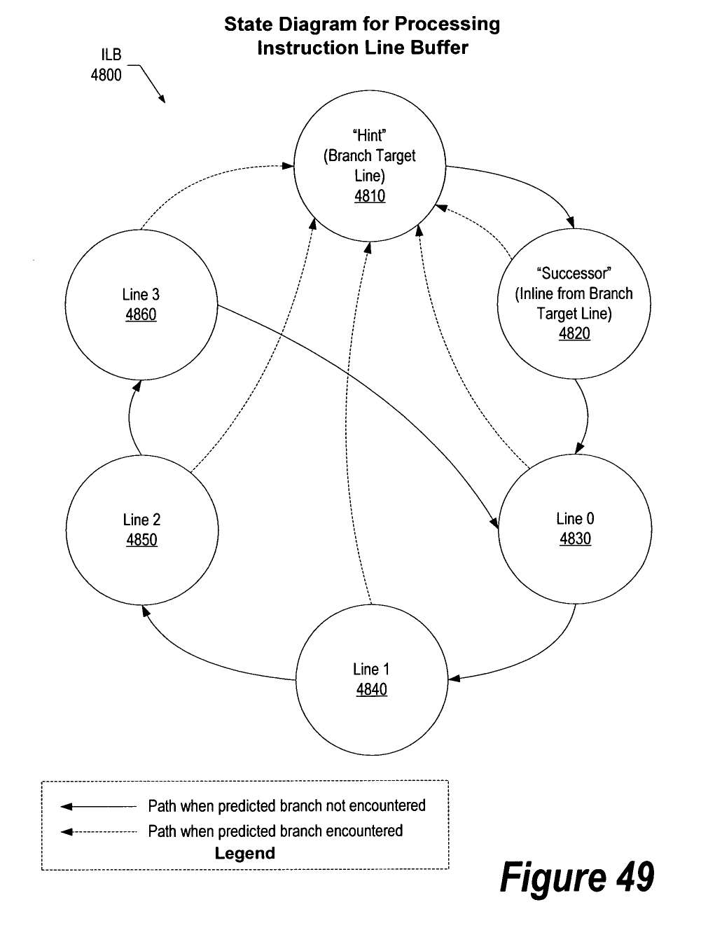

Returning to FIG. 48, when a predicted branch is identified by dispatcher 4870, the dispatcher issues a loadbtb instruction which causes “hint” line 4810 and “successor” line 4820 to be loaded. “Hint” line 4810 includes the branch target address somewhere within the 16 instructions. For efficiency, instruction lines are loaded from local storage on 16 byte boundaries. “Successor” line 4820 includes the next 16 instructions following the line in which the branch target was found. In this manner, even if the branch target address is the last address in the “hint” line, at least 17 instructions have been prefetched (the last instruction in the “hint” line and the next 16 lines in the “successor” line). In a best case (when the branch target is the first instruction in the “hint” line), 32 predicted branch instructions are prefetched (16 in both the “hint” and “successor” lines). Other lines in ILB 4800 are fetched by inline prefetcher 4875. In one embodiment, inline prefetcher 4875 is a hardware-based memory fetcher that fetches inline instructions. If predicted branch instructions are loaded in “hint” line 4810 and “successor” line 4820, then the prefetcher starts taking inline code beginning at the address block following the last address in “successor” block 4820. Instructions that follow “successor” line 4820 are fetched into line 0 (4830), instructions that follow the last instruction fetched into line 0 are fetched into line 1 (4840), instructions that follow the last instruction fetched into line 2 are fetched into line 2 (4850), and instructions that follow the last instruction fetched into line 2 are fetched into line 3 (4860). Finally, instructions that follow the last instruction fetched into line 3 are fetched into line 0 (4830). In this manner, while a predicted branches is not encountered, the prefetcher fetches instruction lines into lines 0, 1, 2, and 3. However, when a predicted branch is encountered, pointers are used to determine when the branch instruction is encountered (i.e., in any of lines 0-3) and then the currently predicted path is switched, at that point, to the predicted branch instructions that have been loaded into “hint” line 4810 and “successor” line 4820. Note that in a short set of branch code, another branch may exist in the “successor” line which causes the CPP to go from the “successor” line back to the “hint” line. As is explained in more detail in FIG. 49-56, state settings associated with each of the lines is used to determine which line becomes the Current Predicted Path line 4880 (also called CPP line 4880). The instructions loaded into the Current Predicted Path are sequenced into to the Issue Control component 4890 of the SPE for issue and execution by the processor.

FIG. 49 is a state diagram showing scheduling order of lines within the ILB. As previously described, the Current Predicted Path (CPP) cycles through the four lines loaded by the hardware-based prefetcher (lines 0 through 3) until a predicted branch is encountered. Following the solid lines (showing flow when a branch has not been predicted), the instructions of line 0 become the CPP, then line 1 becomes the CPP, then line 2 becomes the CPP, and then line 3 becomes the CPP, before circling back where line 0 once again becomes the CPP. When a branch is encountered, software, such as a dispatcher, issues a loadbtb instruction which loads predicted branch instructions in “hint” line 4810 and “successor” line 4820. State information maintained for each of the lines is updated to note the address of the branch instruction (in any one of the lines) as well as the address of the branch target instruction (stored as one of the 16 instructions stored in “hint” line 4810). Now processing follows one of the dashed lines to the “hint” line, depending upon which of the lines the lines contains the branch instruction. For example, if the branch instruction is in line 1 (4840), then the dashed line between line 1 and “hint” line 4810 is taken when the branch instruction is encountered in line 1. In other words, at some point line 1 becomes the CPP and its instructions are sequenced out to issue control. Because of state information maintained for the CPP as well as the other lines, the last instruction of the CPP is identified (i.e., the branch instruction), whereupon the next successor line (i.e., the “hint” line) is loaded as the new CPP. In addition, the branch target instruction might not be the first instruction of the newly loaded CPP, so state information also indicates which instruction within “hint” line is the first instruction to be scheduled. When the last instruction from the “hint” line is processed, the next successor line (i.e., the “successor” line 4820) is loaded (following the solid line from FIG. 49). Successor lines continue to be loaded following the solid lines until a predicted branch is encountered, whereupon, once again, one of the dashed lines is taken back to the “hint” line (the actual dashed line taken leading from the instruction line which includes the branch instruction).

FIG. 50 is a diagram showing data loaded from two banks of memory as a result of a software-initiated “load branch table buffer” (loadbtb) instruction. In one embodiment, local memory store 5000 is divided into two banks, each of which is 64 bytes wide. Bank 0 includes addresses 0-63, 128-191, and so on, while Bank 1 includes addresses 64-127, 192-255, and so on. A software program, such as dispatcher 5030, issues a “load branch target buffer” (loadbtb) instruction with operands that include (1) the address of the branch instruction, and (2) the address of the target of the branch instruction. The address of the branch instruction is used to determine the point at which the next successor line should go from one of the six lines to “hint” line 4810, as explained in FIGS. 48 and 49. The address of the target is used to identify the instruction line in local store 5000 that includes the target address. This instruction line (64 bytes) is then loaded into “hint” line 4810. The next line of instructions is then loaded inline from the other memory bank to “successor” line 4820 within the ILB. In the example shown in FIG. 50, the branch target is located somewhere in Bank 0 (within bytes 0 to 63). This line is loaded as the “hint” line and the “successor” line is located in Bank 1 (bytes 64-127).

FIG. 51 is another diagram of data loaded from two banks of memory as a result of the loadbtb instruction. In this example, the branch target is located somewhere in Bank 1 (within bytes 64-127). This line is loaded as the “hint” line and the “successor” line is located in Bank 0 (bytes 128 to 191). This is one reason why “lines” of the ILB are actually half-lines rather than full lines. If a full line was fetched (bytes 0 to 127), the branch target might be at the end of the line (i.e., target instruction might be at byte 124), in which case the loadbtb would load few, if any successor lines of the predicted branch. Using half-lines, the loadbtb loads the next instruction line (64 bytes) after the “hint” line regardless of the memory bank in which the branch target instruction was found. In this manner, at least 17 predicted branch target instructions are fetched (at least one in the “hint” line if the branch target is the last instruction and 16 instructions in the next half-line).

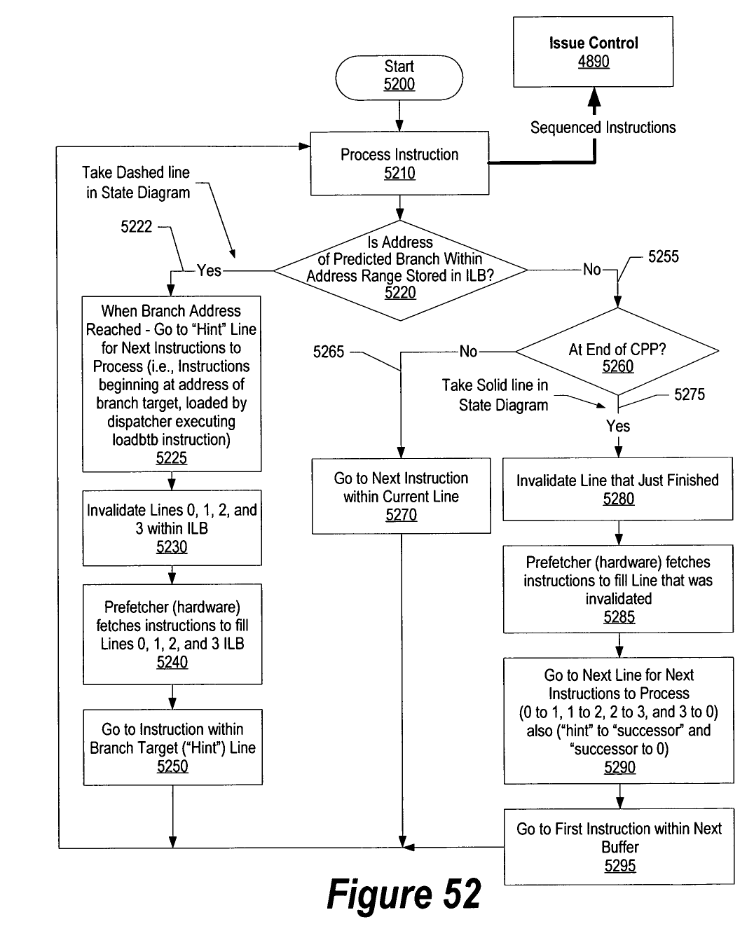

FIG. 52 is a flowchart showing the logical progression through the lines included in the ILB. Processing commences at 5200 whereupon, at step 5210 the next instruction in the Currently Predicted Path (CPP) is processed. A determination is made as to whether the address of the instruction is a predicted branch and is within the address range of instructions stored in the ILB (decision 5220). If the instruction is a branch instruction, then decision 5220 branches to “yes” branch 5222 and, when the branch instruction is reached in the CPP, the “hint” line will be loaded as the next CPP (step 5225). This is synonymous with taking one of the dashed lines in the state diagram shown in FIG. 49. The instruction lines that are loaded by the hardware-based prefetcher (lines 0, 1, 2, and 3) are invalidated at step 5230. The invalidation of these lines causes the hardware prefetcher to begin fetching lines that are subsequent to the “successor” line that was loaded by the loadbtb instruction (step 5240). When the “hint” line has become the CPP, processing commences on the instruction within the “hint” line that corresponds to the address of the branch target (step 5250). Processing then loops back to sequence the instruction out to issue control 4890.

Returning to decision 5220, if the address of the instruction being processed is not within the range of a predicted branch within the address range stored in the ILB, then decision 5220 branches to “no” branch 5255 whereupon another determination is made as to whether the instruction is the last instruction that is to be processed in the CPP (decision 5260). If the instruction is not the last instruction to process in the CPP, then decision 5260 branches to “no” 5265 which causes the next instruction in the CPP to be processed (step 5270). On the other hand, if the instruction is the last instruction in the CPP to be processed, decision 5260 branches to “yes” branch 5275 whereupon (1) the line that just finished processing is invalidated (step 5280), the hardware-based prefetcher fetches instructions to fill the Line that was just invalidated (step 5285), the next successor line is loaded as the new CPP. If the former CPP was the “hint” line, then the “successor” line is loaded as the new CPP. If the former CPP was the “successor” line, then Line 0 is loaded as the new CPP. If the former CPP was Line 0, then Line 1 is loaded as the new CPP. If the former CPP was Line 1, then Line 2 is loaded as the new CPP. If the former CPP was Line 2, then Line 3 is loaded as the new CPP. Finally, if the former CPP was Line 3, then Line 0 is loaded as the new CPP. This is synonymous with taking one of the solid lines in the state diagram shown in FIG. 49.

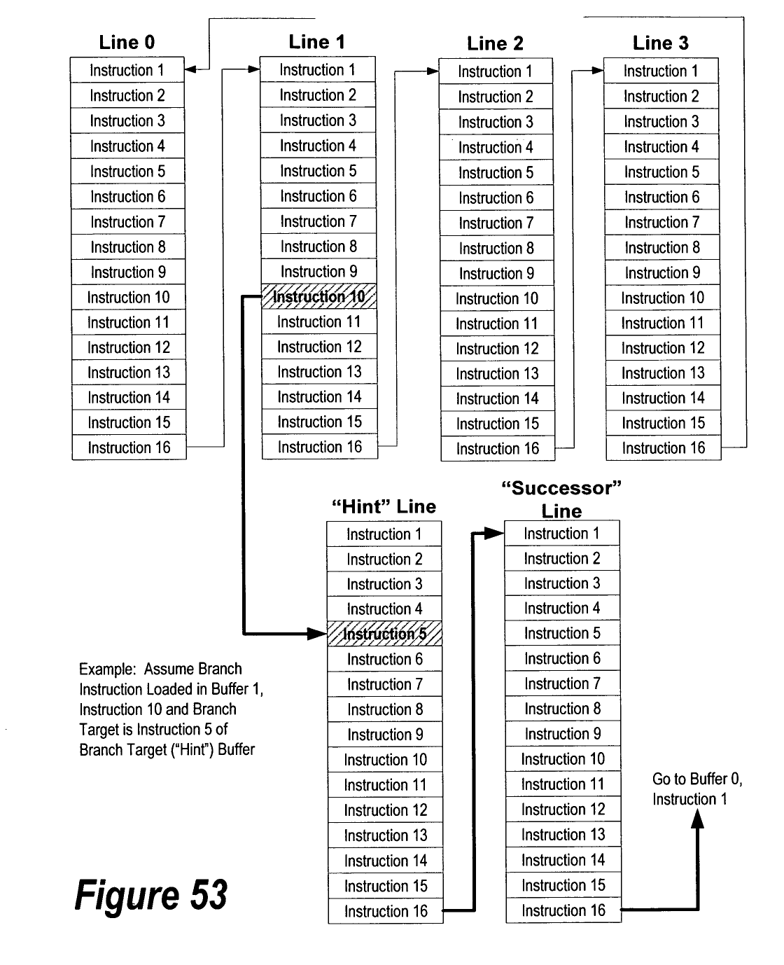

FIG. 53 shows an example progression through the lines included in the ILB when predicted branch target instructions have been loaded. In the example, the branch instruction of the predicted branch is identified as being Instruction 10 within Line 1. State settings are established so that instruction 1 is set as the last instruction of Line 1 to be scheduled and the “successor” line to line 1 is set to be the “hint” line. Further state settings corresponding to the “hint” line are set establishing that Instruction 5 within the “hint” line is the first instruction to be scheduled when the line becomes the CPP. Instruction 5 corresponds with the branch target address provided in the loadbtb instruction that caused the “hint” and “successor” lines to be loaded. Following the thick black line in FIG. 53, it can be seen that after Instruction 10 in Line 1 is scheduled, the next line to be scheduled is Instruction 5 of the “hint” line. Also, after the last instruction of the “hint” line is scheduled (Instruction 16), the next CPP is the “successor” line and the first instruction of the “successor” line to be scheduled is Instruction 1 of the “successor” line. If no intervening loadbtb instructions are issued, when the “successor” line is the CPP and the last instruction (Instruction 16) is scheduled, then the next line to be the CPP after the “successor” line is Line 0 and the first instruction of Line 0 is Instruction 1. When the “hint” line became the CPP, the inline lines (Lines 0 through 3) were invalidated, causing the prefetch hardware to fetch instructions that followed the last instruction in the “successor” line.

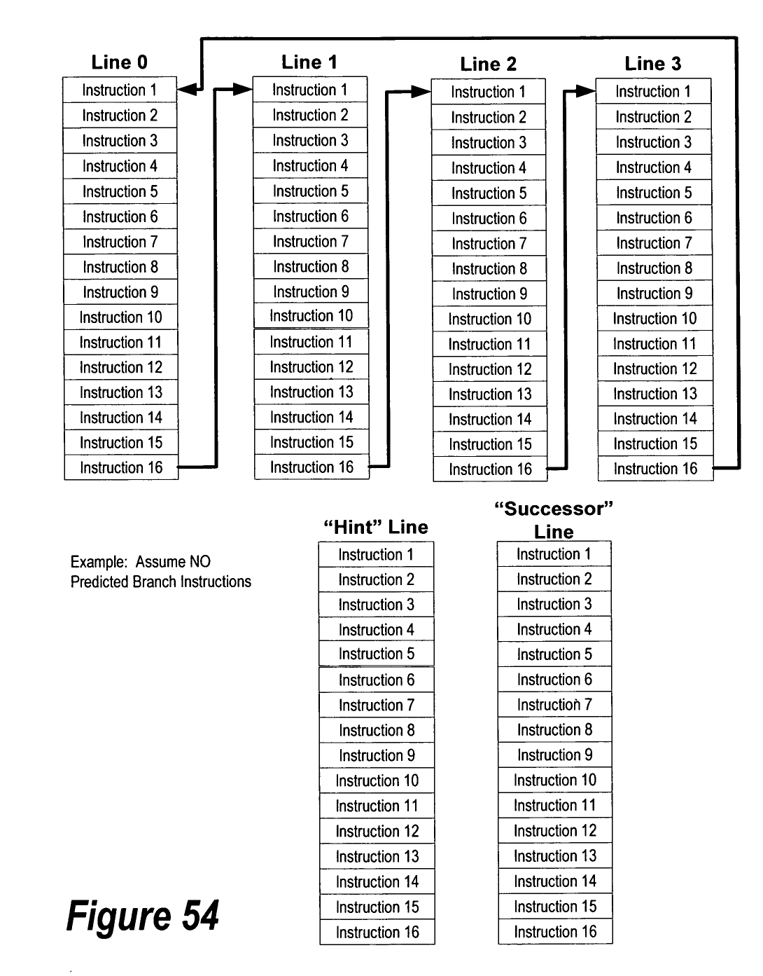

FIG. 54 shows an example progression through the lines included in the ILB when no predicted branch target instructions have been loaded. This figure is similar to FIG. 53, however in FIG. 54 no predicted branch has been encountered. Following the thick black line, lines continue to be loaded as the CPP and instructions of each line continue to be scheduled. Note that because no predicted branches have been encountered, the “hint” and “successor” lines are not used. When one line completes as being the CPP, the line is invalidated so that the prefetcher hardware can re-use the line to load more subsequent instructions. For example, when Line 0 is no longer the CPP (Line 1 becomes the CPP), then Line 0 is invalidated and the prefetcher hardware loads instructions that are subsequent to the instructions that have been loaded in Line 3.

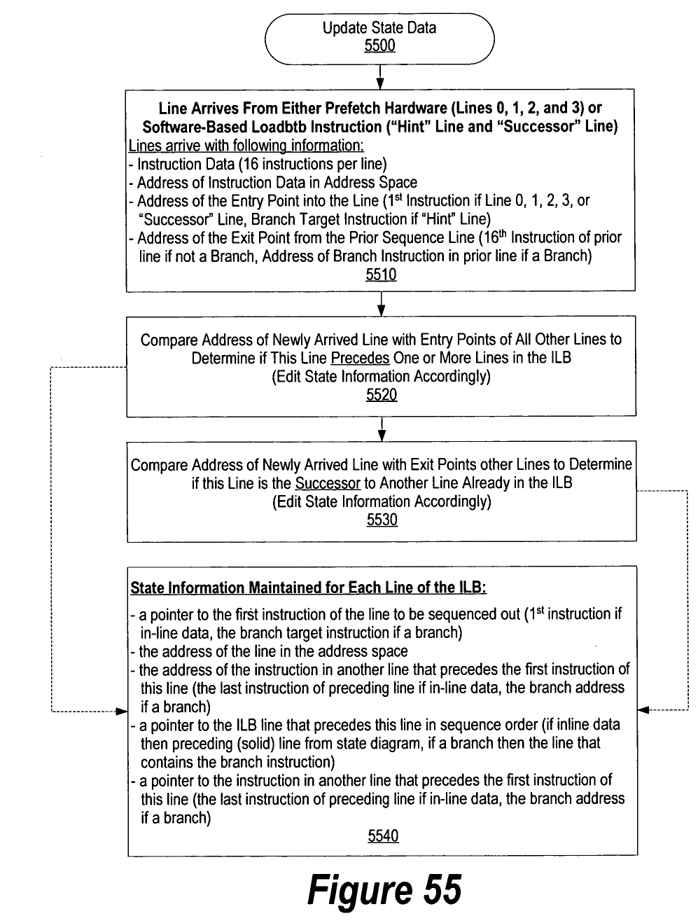

FIG. 55 shows a flowchart detailing steps taken when a new line is loaded in the ILB by either the prefetch hardware or as a result of the loadbtb instruction. Processing commences at 5500 whereupon, at step 5510, a line arrives at the instruction line buffer (ILB) from either the hardware-based prefetcher or as a result of a software program, such as the dispatcher, issuing a loadbtb instruction to load branch target instructions into the instruction line buffer. When a line arrives, it includes the following information: Instruction Data (16 instructions per line), the Address of the Instruction Data in Address Space, the Address of the Entry Point into the Line (1st Instruction if Line 0, 1, 2, 3, or “Successor” Line, Branch Target Instruction if “Hint” Line), and the Address of the Exit Point from the Prior Sequence Line (16th Instruction of prior line if not a Branch, Address of Branch Instruction in prior line if a Branch). The information corresponding to the newly arrived line is used to update that line's state information. At step 5520, the address of the newly arrived line is compared with enrty points of all other lines currently in the ILB to determine whether the line that just arrived precedes, in scheduling order, one of the lines that is already in the ILB, and state information of the lines is updated accordingly. At step 5530, the address of the line that just arrived is compared with the exit points the other lines already in the ILB to determine whether this new line is a successor to another line already in the ILB, and state information of the lines is updated accordingly.

State information is maintained for each line in the ILB (state information 5540). The state information includes a pointer to the first instruction of the line to be sequenced out (1st instruction if in-line data, the branch target instruction if a branch), the address of the line in the address space, the address of the instruction in another line that precedes the first instruction of this line (the last instruction of preceding line if in-line data, the branch address if a branch), a pointer to the ILB line that precedes this line in sequence order (if inline data then preceding (solid) line from state diagram, if a branch then the line that contains the branch instruction), and a pointer to the instruction in another line that precedes the first instruction of this line (the last instruction of preceding line if in-line data, the branch address if a branch). The state information is derived from the information that is included with the line when it arrives at the ILB as well as from comparisons made in steps 5520 and 5530.

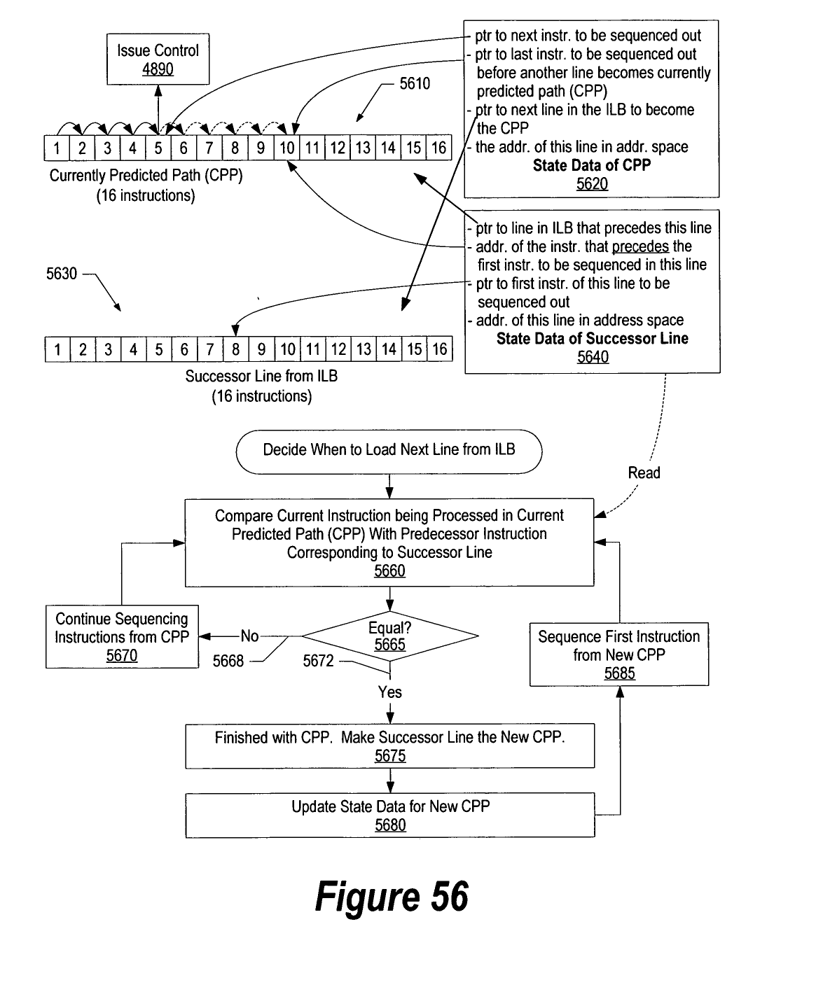

FIG. 56 is a flowchart detailing steps taken in deciding when to load the next scheduled line from the ILB into the Currently Predicted Path (CPP). Instruction line 5610 is the Currently Predicted Path and its instructions will be scheduled and sent to issue control 4890. State data is maintained for the CPP (state data 5620). This state data includes a pointer to next instruction to be sequenced out, a pointer to last instruction to be sequenced out before another line becomes currently predicted path (CPP), a pointer to next line in the ILB to become the CPP, and the address of this line in address space. In the example shown, the pointer to the next instruction to be sequenced out currently points to Instruction 5. Also, in the example shown, the pointer to the last instruction to be sequenced out before another line becomes the CPP points to Instruction 10. Note the solid lines connecting Instructions 1-5 indicating that these lines have been scheduled out and the dashed lines connecting Instructions 5-10 indicating that these lines are yet to be scheduled. No lines connect Instruction 10 to Instructions 11-16 as these instructions will not be scheduled because successor line 5630 will be the CPP after Instruction 10 is scheduled. In other words, Instruction 10 is a branch instruction and successor line 5630 includes instructions that include the branch to instruction. State data of the CPP 5620 also includes a pointer to the next line in the ILB (successor line 5630) that will become the CPP after the last scheduled instruction (Instruction 10 in the example) in CPP 5610 has been scheduled.

State data 5640 is maintained for each of the lines in the ILB, including the line of the ILB that is scheduled to succeed the current CPP and thus become the next CPP. This state data includes a pointer to line in ILB that precedes this line, the address of the instruction that precedes the first instruction to be sequenced in this line, a pointer to first instruction of this line to be sequenced out, and the address of this line in address space. In the example shown, the state data for successor line 5630 points to the CPP as the line in the ILB that precedes this line, the address of the instruction corresponds to the last instruction (Instruction 10) that will be scheduled from the CPP, and the pointer to the first instruction of this line points to Instruction 8 of this line. In other words, Instruction 10 of the CPP is the branch instruction (or, more particularly, the instruction immediately preceding the branch instruction) and the Instruction 8 of the successor line 5630 is the instruction corresponding to the “branch-to address” of the branch instruction. If a branch is not being handled, the last instruction from the CPP would be Instruction 16 and the first instruction of the successor line would be Instruction 1.

To decide when to load the next line from the ILB, the current instruction that is being processed in the CPP is compared with the predecessor instruction maintained in the successor line's state data (step 5660). If the comparison reveals that the two instructions are not the same (i.e., the last instruction of the CPP, in the example, Instruction 10 of the CPP has not been reached), then decision 5665 branches to “no” 5668 whereupon sequencing of the instructions in the CPP continues at 5670 and loops back to check the next scheduled instruction. On the other hand, if the current instruction being processed in the CPP is equal to the predecessor instruction saved in the successor line's state information, the decision 5665 branches to “yes” 5672 whereupon the current CPP is finished and the instructions in the successor line are moved (or copied) to the CPP, thus making the successor line the new CPP (step 5675). State information 5620 is updated in accordance with the state of the new CPP. For example, the pointer to the next instruction to be sequenced out is set to point at Instruction 8 of the new CPP (as Instruction 8 is the first instruction from 5630 to be scheduled out as it corresponds to the branch-to address). The new successor line is determined by the steps previously shown in FIG. 55. In addition, the state diagram shown in FIG. 49 can be used to determine the next line within the ILB that will be the successor to the new CPP.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A method comprising:
receiving a plurality of instruction lines, wherein each of the instruction lines includes a plurality of instructions;
storing the plurality of instruction lines in an instruction line buffer;
maintaining state information related to each of the plurality of instruction lines;
identifying, based upon the state information, one of the plurality of instructions as a next current predicted path;
determining that a last instruction of a current predicted path has been scheduled; and
loading the identified next current predicted path as the current predicted path in response to the determination.

2. The method of claim 1 wherein the instruction line buffer includes a plurality of branch target instruction lines and a plurality of inline instruction lines.

3. The method of claim 2 further comprising:
executing a load branch table buffer command identifying a predicted branch address and a predicted branch target address, the executing including:
retrieving a first branch instruction line from a local memory store, wherein the first branch instruction line includes the predicted branch target address; and
retrieving a second branch instruction line from the local memory store, wherein the second branch instruction line is immediately subsequent to the first branch instruction line.

4. The method of claim 3 further comprising:
identifying the predicted branch address in one of the plurality of instruction lines; and
setting the state information so that predicted branch instruction is the last instruction scheduled in its instruction line and the instruction corresponding to the predicted branch target address is the next instruction scheduled to be executed in first branch instruction line.

5. The method of claim 2 wherein the plurality of inline instruction lines are loaded by a hardware-based prefetcher.

6. The method of claim 1 wherein the state information is selected from the group consisting of a pointer to the first instruction of each instruction line scheduled to be sequenced for execution, an address of each instruction line in a local memory store, an address of an instruction in another of the plurality of lines that precedes the first instruction, a pointer to another of the plurality of instruction lines that precedes the instruction line in sequence order, and a pointer to the instruction in another of the plurality of lines that precedes the first instruction.

7. The method of claim 1 wherein the instruction line buffer includes a plurality of branch target instruction lines and a plurality of inline instruction lines, the method further comprising:
repeatedly identifying a current predicted path from the plurality of instruction lines, wherein the instructions in the current predicted path are scheduled for execution, and
wherein the current predicted path includes the plurality of branch target instruction lines and the inline instruction lines when a branch is encountered; and
wherein the current predicted does not include the plurality of branch target lines but does include the inline instruction lines when a branch is not encountered.

8. An information handling system comprising:
a processor;
an instruction line buffer into which predicted instruction lines are stored for execution on the processor;
a local store accessible by the processor, wherein the local store includes a plurality of instruction lines, each of which includes a plurality of instructions;
an issue control component for receiving scheduled instructions from the instruction line buffer; and
an instruction line buffer tool for managing the retrieval and scheduling of the instruction lines, the instruction line buffer tool including:
means for receiving the plurality of instruction lines;
means for storing the plurality of instruction lines in the instruction line buffer;
means for maintaining state information related to each of the plurality of instruction lines;
means for identifying, based upon the state information, one of the plurality of instructions as a next current predicted path;
means for determining that a last instruction of a current predicted path has been scheduled; and
means for loading the identified next current predicted path as the current predicted path in response to the determination.

9. The information handling system of claim 8 wherein the instruction line buffer includes a plurality of branch target instruction lines and a plurality of inline instruction lines.

10. The information handling system of claim 9 further comprising:
means for executing a load branch table buffer command identifying a predicted branch address and a predicted branch target address, the executing including:
means for retrieving a first branch instruction line from a local memory store, wherein the first branch instruction line includes the predicted branch target address; and
means for retrieving a second branch instruction line from the local memory store, wherein the second branch instruction line is immediately subsequent to the first branch instruction line.

11. The information handling system of claim 10 further comprising:
means for identifying the predicted branch address in one of the plurality of instruction lines; and
means for setting the state information so that predicted branch instruction is the last instruction scheduled in its instruction line and the instruction corresponding to the predicted branch target address is the next instruction scheduled to be executed in first branch instruction line.

12. The information handling system of claim 9 wherein the plurality of inline instruction lines are loaded by a hardware-based prefetcher.

13. The information handling system of claim 8 wherein the state information is selected from the group consisting of a pointer to the first instruction of each instruction line scheduled to be sequenced for execution, an address of each instruction line in a local memory store, an address of an instruction in another of the plurality of lines that precedes the first instruction, a pointer to another of the plurality of instruction lines that precedes the instruction line in sequence order, and a pointer to the instruction in another of the plurality of lines that precedes the first instruction.

14. The information handling system of claim 8 wherein the instruction line buffer includes a plurality of branch target instruction lines and a plurality of inline instruction lines, the information handling system further comprising:
repeatedly identifying a current predicted path from the plurality of instruction lines, wherein the instructions in the current predicted path are scheduled for execution, and
wherein the current predicted path includes the plurality of branch target instruction lines and the inline instruction lines when a branch is encountered; and
wherein the current predicted does not include the plurality of branch target lines but does include the inline instruction lines when a branch is not encountered.

15. A computer program product stored on a computer operable media comprising:
means for receiving a plurality of instruction lines, wherein each of the instruction lines includes a plurality of instructions;
means for storing the plurality of instruction lines in an instruction line buffer;
means for maintaining state information related to each of the plurality of instruction lines;
means for identifying, based upon the state information, one of the plurality of instructions as a next current predicted path;
means for determining that a last instruction of a current predicted path has been scheduled; and
means for loading the identified next current predicted path as the current predicted path in response to the determination.

16. The computer program product of claim 15 wherein the instruction line buffer includes a plurality of branch target instruction lines and a plurality of inline instruction lines.

17. The computer program product of claim 16 further comprising:
means for executing a load branch table buffer command identifying a predicted branch address and a predicted branch target address, the executing including:
means for retrieving a first branch instruction line from a local memory store, wherein the first branch instruction line includes the predicted branch target address; and
means for retrieving a second branch instruction line from the local memory store, wherein the second branch instruction line is immediately subsequent to the first branch instruction line.

18. The computer program product of claim 17 further comprising:
means for identifying the predicted branch address in one of the plurality of instruction lines; and
means for setting the state information so that predicted branch instruction is the last instruction scheduled in its instruction line and the instruction corresponding to the predicted branch target address is the next instruction scheduled to be executed in first branch instruction line.

19. The computer program product of claim 16 wherein the plurality of inline instruction lines are loaded by a hardware-based prefetcher.

20. The computer program product of claim 15 wherein the state information is selected from the group consisting of a pointer to the first instruction of each instruction line scheduled to be sequenced for execution, an address of each instruction line in a local memory store, an address of an instruction in another of the plurality of lines that precedes the first instruction, a pointer to another of the plurality of instruction lines that precedes the instruction line in sequence order, and a pointer to the instruction in another of the plurality of lines that precedes the first instruction.
